(19) United States
(12) Patent Application Publication
(10) Pub. No.: US 2016/0233478 A1
(43) Pub. Date: Aug. 11, 2016

(54) RECTANGULAR ELECTRICITY STORAGE DEVICE AND METHOD FOR PRODUCING THE SAME

(71) Applicant: SUMITOMO ELECTRIC INDUSTRIES, LTD., Osaka-shi (JP)

(72) Inventors: Mizuo Iwasaki, Osaka-shi (JP); Yasushi Mochida, Osaka-shi (JP)

(21) Appl. No.: 15/023,530

(22) PCT Filed: Sep. 22, 2014
(86) PCT No.: PCT/JP2014/075081

§ 371 Date: Mar. 21, 2016

(30) Foreign Application Priority Data
Sep. 30, 2013 (JP) 2013-205504
Aug. 22, 2014 (JP) 2014-169117

(51) Int. Cl. H01M 2/26; H01M 10/04; H01G 11/86; H01M 2/30; H01G 11/74; H01G 11/26

(52) U.S. Cl. CPC H01M 2/266; H01G 11/74; H01G 11/26; H01G 11/86; H01M 2/26; H01M 2/30; H01M 10/049; H01M 10/0413

(57) ABSTRACT

In a rectangular electricity storage device, a first electrode group and a second electrode group that are housed in an outer package can 2 are respectively provided with a first terminal portion and a second terminal portion that extend from end surfaces 13 toward an opening 21 of the outer package can 2, the end surfaces 13 facing the opening 21. The first electrode group and the second electrode group are mechanically and electrically coupled to each other by a connection member. Specifically, the connection member includes a first connecting portion welded to the first terminal portion, a second connecting portion welded to the second terminal portion, and a coupling portion that mechanically and electrically couples the first connecting portion and the second connecting portion to each other. An inner surface 31 of a cover plate 3 is provided with a projecting portion that extends from the inner surface 31 toward a bottom surface of the outer package can 2. The projecting portion is electrically connected to an external terminal and is welded to at least any one of the first terminal portion, the second terminal portion, and the connection member.

### TECHNICAL FIELD

The present invention relates to a rectangular electricity storage device in which a plurality of electrode groups are housed in an outer package can and to a method for producing the same.

### BACKGROUND ART

FIG. 25 is a longitudinal cross-sectional view that conceptually illustrates an example of an existing rectangular electricity storage device. As illustrated in FIG. 25, the existing rectangular electricity storage device includes a plurality of electrode groups 101, a bottom-closed cylindrical outer package can 102 that houses these electrode groups 101, a cover plate 103 that seals an opening 102a of the outer package can 102, and a positive electrode external terminal 104 and a negative electrode external terminal (not illustrated) that are provided on the cover plate 103 (refer to, for example, PTL 1). Although not illustrated in the figure, in each of the electrode groups 101, a plurality of positive electrode plates and a plurality of negative electrode plates are alternately stacked with separators therebetween. Each of the positive electrode plates has a positive electrode tab protruding from an edge facing the opening 102a of the outer package can 102. Each of the negative electrode plates has a negative electrode tab protruding from an edge facing the opening 102a of the outer package can 102. Each of the electrode groups 101 includes a positive electrode terminal portion 105 which is a bundle including a plurality of overlapping positive electrode tabs belonging to the electrode group 101, and a negative electrode terminal portion (not illustrated) which is a bundle including a plurality of overlapping negative electrode tabs belonging to the electrode group 101.

In the existing rectangular electricity storage device, an end of a positive electrode lead plate 106 is welded to each positive electrode terminal portion 105. A plurality of positive electrode lead plates 106 provided on the corresponding positive electrode terminal portions 105 are bundled into one, and another end of the bundled positive electrode lead plates 106 are welded on the positive electrode external terminal 104 or fixed to the positive electrode external terminal 104 with a screw. The bundled positive electrode lead plates 106 are folded in a space in the outer package can 102, the space being formed between the cover plate 103 and the electrode groups 101. In this manner, each of the positive electrode terminal portions 105 is electrically connected to the positive electrode external terminal 104 with the corresponding positive electrode lead plate 106 therebetween. Similarly, each of the negative electrode terminal portions is electrically connected to the negative electrode external terminal with a corresponding negative electrode lead plate therebetween.

In a process for producing the existing rectangular electricity storage device, first, a plurality of electrode groups 101 to be housed in an outer package can 102 are prepared, and, in each of the electrode groups 101, a positive electrode lead plate 106 and a negative electrode lead plate are welded on a positive electrode terminal portion 105 and a negative electrode terminal portion, respectively. Next, the electrode groups 101 are stacked so that the positive electrode lead plates 106 and the negative electrode lead plates attached to the electrode groups 101 are oriented in the same direction, and the electrode groups 101 are housed in the outer package can 102 so that the positive electrode lead plates 106 and the negative electrode lead plates are led out from an opening of the outer package can 102. Consequently, the electrode groups 101 are fixed to a predetermined position in the outer package can 102. Subsequently, the positive electrode lead plates 106 are bundled into one and welded to a positive electrode external terminal 104 in the outside of the outer package can 102. Similarly, the negative electrode lead plates are bundled into one and welded to a negative electrode external terminal in the outside of the outer package can 102. Subsequently, the bundled positive electrode lead plates 106 and the bundled negative electrode lead plates are folded and housed in the outer package can 102. An opening 102a of the outer package can 102 is sealed with a cover plate 103.

### CITATION LIST

### Patent Literature

PTL 1: Japanese Unexamined Patent Application Publication No. 2011-165475

### SUMMARY OF INVENTION

### Technical Problem

In the existing rectangular electricity storage device, it is necessary that, after the electrode groups 101 are housed in the outer package can 102, the positive electrode lead plates 106 be bundled into one and welded to the positive electrode external terminal 104 or fixed to the positive electrode external terminal 104 with a screw, and that the negative electrode lead plates be bundled into one and welded to the negative electrode external terminal or fixed to the negative electrode external terminal with a screw. The reason for this is as follows. Even if a plurality of electrode groups 101 can be stacked on one another without misalignment before the electrode groups 101 are housed in the outer package can 102, misalignment of the electrode groups 101 may occur when the positive electrode lead plates 106 are bundled into one and welded to the positive electrode external terminal 104 or fixed to the positive electrode external terminal 104 with a screw, and the negative electrode lead plates are bundled into one and welded to the negative electrode external terminal or fixed to the negative electrode external terminal with a screw. When misalignment of the electrode groups 101 occurs, it is difficult to house the electrode groups 101 in the outer package can 102.

In view of the circumstances described above, it is necessary to house the electrode groups 101 in the outer package can 102 in advance. Accordingly, as the positive electrode lead plates 106 and the negative electrode lead plates, it is necessary to use plates having such a length that when the electrode groups 101 are housed in the outer package can 102, the plates can be led to the outside of the outer package can 102. Therefore, a space for housing the positive electrode lead plates 106 and the negative electrode lead plates is provided in the outer package can 102. The positive electrode lead plates 106 and the negative electrode lead plates are folded and housed in the space when the opening 102a of the outer package can 102 is sealed with the cover plate 103.

In recent years, with an increase in the capacity of electricity storage devices, the current drawn from the electricity storage devices has been increasing. Therefore, the Joule heat generated due to the electrical resistance of lead plates increases, and the lead plates may cause a significant energy loss. In order to reduce the Joule heat generated in lead plates, the cross-sectional area of each of the lead plates may be increased to decrease the electrical resistance of the lead plate. An example of a simple method for increasing the cross-sectional area of a lead plate is to increase the thickness of the lead plate.

On the other hand, if the thickness of each lead plate is increased, it is necessary to increase the size of the space in which the lead plates are folded and housed. For example, the inner dimensions of the outer package can 102 may be increased, or a ratio of the space occupied by the electrode groups 101 in the outer package can 102 may be decreased. However, in these methods, an improvement in the volume energy density may be hindered. Furthermore, in the case where the thickness of a lead plate is increased, during the folding of the lead plate, breakage and damage tend to occur in a folded portion of the lead plate. In order to prevent the occurrence of such breakage and damage, the lead plate needs to have a thickness of less than 0.2 mm.

Accordingly, an object of the present invention is to provide a rectangular electricity storage device having a high volume energy density and a low energy loss between an external terminal and electrode groups.

### Solution to Problem

An aspect of the present invention relates to a rectangular electricity storage device. The rectangular electricity storage device includes a first electrode group and a second electrode group, a bottom-closed cylindrical outer package can, a cover plate that seals an opening of the outer package can, an external terminal disposed on the cover plate, and a connection member. In each of the first electrode group and the second electrode group, a plurality of first electrode plates and a plurality of second electrode plates having a polarity opposite to the first electrode plates are stacked. In the outer package can, the first electrode group and the second electrode group are housed in a stacked state. The first electrode plates are each provided with an electrode tab that protrudes from an edge toward the opening of the outer package can, the edge facing the opening. The first electrode group is provided with a first terminal portion that extends from an end surface toward the opening of the outer package can, the end surface facing the opening, the electrode tabs provided on the first electrode plates belonging to the first electrode group overlap and form a bundle, and the bundle constitutes the first terminal portion. The second electrode group is provided with a second terminal portion that extends from an end surface toward the opening of the outer package can, the end surface facing the opening, the electrode tabs provided on the first electrode plates belonging to the second electrode group overlap and form a bundle, and the bundle constitutes the second terminal portion. The connection member mechanically and electrically couples the first electrode group and the second electrode group to each other. Specifically, the connection member includes a first connecting portion welded to the first terminal portion, a second connecting portion welded to the second terminal portion, and a coupling portion that mechanically and electrically couples the first connecting portion and the second connecting portion to each other. An inner surface of the cover plate is provided with a projecting portion that extends from the inner surface toward a bottom surface of the outer package can, and the projecting portion is electrically connected to the external terminal and is welded to at least any one of the first terminal portion, the second terminal portion, and the connection member.

Another aspect of the present invention relates to a method for producing a rectangular electricity storage device. The production method includes steps (i) to (v). In the step (i), a connection member is prepared. In the step (ii), a first terminal portion provided on a first electrode group is welded to a first connecting portion of the connection member. In the step (iii), a second electrode group is stacked on the first electrode group, and a second terminal portion provided on the second electrode group is welded to a second connecting portion of the connection member. After the steps (i) to (iii), in the step (iv), a projecting portion provided on an inner surface of a cover plate is welded to at least any one of the first terminal portion, the second terminal portion, and the connection member. After the step (iv), in the step (v), the first electrode group and the second electrode group are housed in an outer package can, and an opening of the outer package can is sealed with the cover plate.

### Advantageous Effects of Invention

According to the aspects of the present invention, the volume energy density is increased, and an energy loss between an external terminal and electrode groups is decreased.

### BRIEF DESCRIPTION OF DRAWINGS

FIG. 1 is a perspective view that conceptually illustrates a rectangular electricity storage device according to an embodiment of the present invention.

FIG. 2 is an exploded perspective view of the rectangular electricity storage device.

FIG. 3 is a side view illustrating an inner structure of the rectangular electricity storage device, viewed from a first sidewall side of an outer package can included in the rectangular electricity storage device.

FIG. 4 is a side view illustrating an inner structure of the rectangular electricity storage device, viewed from a second sidewall side of an outer package can included in the rectangular electricity storage device.

FIG. 5A is a longitudinal cross-sectional view that conceptually illustrates a structure of a positive electrode of each of a plurality of electrode groups included in the rectangular electricity storage device.

FIG. 5B is a longitudinal cross-sectional view that conceptually illustrates a structure of a negative electrode of each of a plurality of electrode groups included in the rectangular electricity storage device.

FIG. 6A is a perspective view illustrating a structure of a positive electrode terminal member included in the rectangular electricity storage device.

FIG. 6B is a perspective view illustrating a structure of a negative electrode terminal member included in the rectangular electricity storage device.

FIG. 7A is a perspective view illustrating a structure of a positive electrode connection member included in the rectangular electricity storage device.

FIG. 7B is a perspective view illustrating a structure of a negative electrode connection member included in the rectangular electricity storage device.

FIG. 8 is a perspective view illustrating a state in which the positive electrode connection member and the negative electrode connection member are connected to electrode groups.

FIG. 9 is a perspective view used for illustrating a step (A) included in a first welding step.

FIG. 10 is a perspective view used for illustrating a step (B) included in the first welding step.

FIG. 11 is a perspective view used for illustrating a step (C) included in the first welding step.

FIG. 12 is a perspective view used for illustrating a step (D) included in the first welding step.

FIG. 13 is a perspective view used for illustrating a step (E) included in a second welding step.

FIG. 14 is a perspective view used for illustrating a step (F) included in the second welding step.

FIG. 15A is a perspective view illustrating a structure of each of a positive electrode connection member and a negative electrode connection member included in a rectangular electricity storage device according to a first modification.

FIG. 15B is a perspective view illustrating a state in which the positive electrode connection member and the negative electrode connection member included in the rectangular electricity storage device according to the first modification are connected to electrode groups.

FIG. 16 is a perspective view used for illustrating a step (A′) included in a first welding step of the first modification.

FIG. 17 is a perspective view used for illustrating a step (B′) included in the first welding step of the first modification.

FIG. 18 is a perspective view used for illustrating a step (C′) included in the first welding step of the first modification.

FIG. 19 is a perspective view used for illustrating a step (D′) included in the first welding step of the first modification.

FIG. 20A is a perspective view illustrating a structure of each of a positive electrode connection member and a negative electrode connection member included in a rectangular electricity storage device according to a second modification.

FIG. 20B is a perspective view illustrating a state in which the positive electrode connection member and the negative electrode connection member included in the rectangular electricity storage device according to the second modification are connected to electrode groups.

FIG. 21 is a perspective view used for illustrating a step (A′) included in a first welding step of the second modification.

FIG. 22 is a perspective view used for illustrating a step (B′) included in the first welding step of the second modification.

FIG. 23 is a perspective view used for illustrating a step (C′) included in the first welding step of the second modification.

FIG. 24 is a perspective view used for illustrating a step (D′) included in the first welding step of the second modification.

FIG. 25 is a longitudinal cross-sectional view that conceptually illustrates an example of an existing rectangular electricity storage device.

### REFERENCE SIGNS LIST

1A, 1B, 1C, 1D electrode group
11A, 11B, 11C, 11D positive electrode terminal portion
111A, 111B, 111C, 111D first surface
112A, 112B, 112C, 112D second surface
12A, 12B, 12C, 12D negative electrode terminal portion
121A, 121B, 121C, 121D first surface
122A, 122B, 122C, 122D second surface
13 end surface
14 positive electrode plate
141 edge
142 positive electrode tab
15 negative electrode plate
151 edge
152 negative electrode tab
16 separator
17A, 17B, 17C, 17D first surface
18A, 18B, 18C, 18D second surface
2 outer package can
21 opening
22 bottom surface
23 first sidewall
24 second sidewall
3 cover plate
31 inner surface
32, 33 nut
4 positive electrode terminal member
41 positive electrode base portion
411 main surface
412 edge
42 positive electrode external terminal
43 positive electrode projecting portion
5 negative electrode terminal member
51 negative electrode base portion
52 negative electrode external terminal
53 negative electrode projecting portion
6 positive electrode connection member
61A, 61B, 61C, 61D positive electrode connecting portion
611A, 611B, 611C, 611D first edge
612A, 612B, 612C, 612D second edge
613A, 613B, 613C facing part
614A, 614B, 614C non-facing part
615A, 615B, 615C, 615D first side edge
616A, 616B, 616C, 616D second side edge
62a, 62b, 62c positive electrode coupling portion
62d, 62e, 62f positive electrode coupling portion
7 negative electrode connection member
71A, 71B, 71C, 71D negative electrode connecting portion
713B, 713C, 713D facing part
714B, 714C, 714D non-facing par
72a, 72b, 72c negative electrode coupling portion
72d, 72e, 72f negative electrode coupling portion
8 electric insulation sheet
81, 82 window
9, 9A, 9B ultrasonic welder
91, 91A horn
92, 92A anvil
911 first welding end
912 second welding end
L distance
L1a, L1b, L1c distance
L2a, L2b, L2c distance
RA1, RB1, RC1, RD1, RP1 predetermined region
RA2, RB2, RC2, RD2, RP2 predetermined region
101 electrode group
102 outer package can
102a opening
103 cover plate
104 positive electrode external terminal
105 positive electrode terminal portion
106 positive electrode lead plate

### DESCRIPTION OF EMBODIMENTS

A rectangular electricity storage device according to an embodiment of the present invention includes a first electrode group and a second electrode group, a bottom-closed cylindrical outer package can, a cover plate that seals an opening of the outer package can, an external terminal disposed on the cover plate, and a connection member. In each of the first electrode group and the second electrode group, a plurality of first electrode plates and a plurality of second electrode plates having a polarity opposite to the first electrode plates are stacked. The first electrode group and the second electrode group are housed in the outer package can in a stacked state. The first electrode plates are each provided with an electrode tab that protrudes from an edge toward the opening of the outer package can, the edge facing the opening. The first electrode group is provided with a first terminal portion that extends from an end surface toward the opening of the outer package can, the end surface facing the opening, the electrode tabs provided on the first electrode plates belonging to the first electrode group overlap and form a bundle, and the bundle constitutes the first terminal portion. The second electrode group is provided with a second terminal portion that extends from an end surface toward the opening, the end surface facing the opening of the outer package can, the electrode tabs provided on the first electrode plates belonging to the second electrode group overlap and form a bundle, and the bundle constitutes the second terminal portion. The connection member mechanically and electrically couples the first electrode group and the second electrode group to each other. Specifically, the connection member includes a first connecting portion welded to the first terminal portion, a second connecting portion welded to the second terminal portion, and a coupling portion that mechanically and electrically couples the first connecting portion and the second connecting portion to each other. An inner surface of the cover plate is provided with a projecting portion that extends from the inner surface toward a bottom surface of the outer package can, and the projecting portion is electrically connected to the external terminal and is welded to at least any one of the first terminal portion, the second terminal portion, and the connection member.

The term “rectangular electricity storage device” covers devices having a rounded corner or a rounded edge. The first electrode plates are positive electrode plates, and the second electrode plates are negative electrode plates. Alternatively, the first electrode plates are negative electrode plates, and the second electrode plates are positive electrode plates. The electricity storage device is not particularly limited as long as the electricity storage device is a device that can perform charging and discharging. Typical examples of the electricity storage device include batteries and capacitors (condensers). Examples of the batteries include a lead storage battery, a lithium-ion battery, and a molten-salt battery. Examples of the capacitors include an electric double-layer capacitor and a lithium-ion capacitor.

According to the rectangular electricity storage device described above, in a process for producing the rectangular electricity storage device, before the first electrode group and the second electrode group are housed in the outer package can, the first electrode group and the second electrode group can be integrated by being fixed to the connection member in a state in which these electrode groups are stacked. Misalignment is unlikely to occur in the first electrode group and the second electrode group which are fixed to the connection member. Accordingly, even before the first electrode group and the second electrode group are housed in the outer package can, the projecting portion provided on the cover plate can be welded to at least any one of the first terminal portion, the second terminal portion, and the connection member without causing misalignment of the first electrode group and the second electrode group. Thus, the cover plate is fixed to the first electrode group and the second electrode group, and the first electrode group and the second electrode group are electrically connected to the external terminal through the connection member. Even after welding of the cover plate, misalignment does not substantially occur in the first electrode group and the second electrode group, and thus the first electrode group and the second electrode group can be housed in the outer package can 2.

Therefore, the rectangular electricity storage device does not require the space for housing lead plates that are folded, the space being necessary for the existing rectangular electricity storage device. Consequently, the ratio of the total volume of the electrode groups to the volume of the rectangular electricity storage device increases, resulting in an improvement in the volume energy density. From the viewpoint of improving the volume energy, in a direction from the bottom surface of the outer package can to the opening of the outer package can, a ratio of a height of the first terminal portion from the end surface, the first terminal portion being provided on the first electrode group, to a distance from the end surface of the first electrode group to the inner surface of the cover plate, the end surface facing the opening of the outer package can, is preferably 0.9 or less.

In the existing rectangular electricity storage device, the thickness of each lead plate must be small in order to prevent breakage and damage from occurring in a folded portion of the lead plate. In contrast, in the rectangular electricity storage device described above, since such breakage and damage do not occur in the connection member, the connection member can have a large thickness. Even when the connection member has a large thickness, the volume energy density does not significantly decrease.

Therefore, according to the rectangular electricity storage device, the electrical resistance of the connection member is low, and an energy loss between the external terminal and the electrode groups is decreased. From the viewpoint of decreasing the energy loss, the connection member is preferably formed of at least one metal selected from the group consisting of aluminum, copper, and nickel. The thickness of the connection member is preferably 0.1 mm or more and 2.0 mm or less, and more preferably 0.5 mm or more and 1.5 mm or less.

In a specific preferred structure of the rectangular electricity storage device, the first terminal portion and the second terminal portion each have a first surface oriented in a first direction that is the same as a direction in which the first electrode group and the second electrode group are stacked and a second surface oriented in a direction opposite to the first direction, and the first connecting portion and the second connecting portion are welded to the first surface of the first terminal portion and the second surface of the second terminal portion, respectively. The first connecting portion and the second connecting portion each have a first edge facing the opening of the outer package can and a second edge on the side opposite to the opening, and the first edges or the second edges are mechanically and electrically coupled to each other by the coupling portion.

The connection member is formed by, for example, bending a single metal flat plate, and thus has high mechanical strength. Therefore, the occurrence of misalignment is prevented in the first electrode group and the second electrode group that are fixed to the connection member.

More specifically, the rectangular electricity storage device has the following structures (1) and (2). In the structure (1), the first surface of the first terminal portion and the second surface of the second terminal portion are surfaces that face each other, and the second edges are mechanically and electrically coupled to each other by the coupling portion. In the structure (2), the first surface of the first terminal portion and the second surface of the second terminal portion are respectively a back surface of the second surface of the first terminal portion and a back surface of the first surface of the second terminal portion, the second surface of the first terminal portion and the first surface of the second terminal portion facing each other, and the first edges are mechanically and electrically coupled to each other by the coupling portion.

By combining these structures (1) and (2), a connection member that has a recess and a protrusion and that can be formed from a single metal flat plate is obtained. This connection member is used in a rectangular electricity storage device in which three or more electrode groups are housed in an outer package can. In this case, the volume energy density can be improved in the rectangular electricity storage device.

In a specific more preferred structure of the structure (2), the first edge of the first connecting portion and the first edge of the second connecting portion each have a coupled region to which the coupling portion is coupled and an exposed region to which the coupling portion is not coupled, and the first connecting portion and the second connecting portion are respectively welded to the first terminal portion and the second terminal portion in a part close to the exposed region.

For example, in the case where ultrasonic welding or resistance welding is used as welding means, it is necessary to sandwich a welding position with a first welding tool and a second welding tool. In the process for producing the rectangular electricity storage device, when the welding position is close to the coupled region, it is difficult to sandwich the welding position with the first welding tool and the second welding tool. In contrast, when the welding position is close to the exposed region, it is easy to sandwich the welding position with the first welding tool and the second welding tool. Consequently, welding of the first and second terminal portions and the connection member is easily performed in the production process.

In another specific preferred structure of the rectangular electricity storage device, the first connecting portion includes a facing part that faces the second connecting portion, and a non-facing part that does not face the second connecting portion, and the first connecting portion is welded to the first terminal portion or the projecting portion in the non-facing part.

For example, in the case where ultrasonic welding or resistance welding is used as welding means, it is necessary to sandwich a welding position with a first welding tool and a second welding tool. In the process for producing the rectangular electricity storage device, when the welding position is the facing part of the first connecting portion, a first welding tool and a second welding tool that have special shapes are necessary in order to sandwich the first connecting portion and the first terminal portion at the welding position. In contrast, when the welding position is the non-facing part of the first connecting portion, the welding position can be sandwiched with a first welding tool and a second welding tool that have been hitherto used.

In another specific preferred structure of the rectangular electricity storage device, the first connecting portion and the second connecting portion each have a side edge, and the side edges are mechanically and electrically connected to each other by the coupling portion.

For example, in the case where ultrasonic welding or resistance welding is used as welding means, it is necessary to sandwich a welding position with a first welding tool and a second welding tool. According to the rectangular electricity storage device, the welding position is easily sandwiched with the first welding tool and the second welding tool. Consequently, welding of the first and second terminal portions and the connection member is easily performed in the production process.

A production method according to an embodiment of the present invention is a method for producing the rectangular electricity storage device described above and includes steps (i) to (v). In the step (i), the connection member is prepared. In the step (ii), the first terminal portion provided on the first electrode group is welded to the first connecting portion of the connection member. In the step (iii), the second electrode group is stacked on the first electrode group, and the second terminal portion provided on the second electrode group is welded to the second connecting portion of the connection member. After the steps (i) to (iii), in the step (iv), the projecting portion provided on the inner surface of the cover plate is welded to at least any one of the first terminal portion, the second terminal portion, and the connection member. After the step (iv), in the step (v), the first electrode group and the second electrode group are housed in the outer package can, and the opening of the outer package can is sealed with the cover plate.

According to the above production method, before the first electrode group and the second electrode group are housed in the outer package can, in the steps (ii) and (iii), the first electrode group and the second electrode group are integrated by being fixed to the connection member in a state in which these electrode groups are stacked. Misalignment is unlikely to occur in the first electrode group and the second electrode group which are fixed to the connection member. Accordingly, even before the first electrode group and the second electrode group are housed in the outer package can, in the step (iv), the projecting portion provided on the cover plate can be welded to at least any one of the first terminal portion, the second terminal portion, and the connection member without causing misalignment of the first electrode group and the second electrode group. Thus, the cover plate is fixed to the first electrode group and the second electrode group, and the first electrode group and the second electrode group are electrically connected to the external terminal through the connection member. Even after the step (iv), misalignment does not substantially occur in the first electrode group and the second electrode group, and thus the first electrode group and the second electrode group can be housed in the outer package can 2.

Therefore, according to the above production method, the space for housing lead plates that are folded, the space being necessary for the existing rectangular electricity storage device, is unnecessary. Consequently, in a rectangular electricity storage device to be produced, the ratio of the total volume of the electrode groups to the volume of the rectangular electricity storage device increases, resulting in an improvement in the volume energy density.

In the existing rectangular electricity storage device, the thickness of each lead plate must be small in order to prevent breakage and damage from occurring in a folded portion of the lead plate. In contrast, in the above production method, since such breakage and damage do not occur in the connection member, the connection member can have a large thickness. Even when the connection member has a large thickness, the volume energy density does not significantly decrease. Therefore, according to the above production method, the electrical resistance of the connection member is low, and an energy loss between the external terminal and the electrode groups is decreased in a rectangular electricity storage device to be produced.

From the viewpoint of increasing the strength of the connection member, in the step (i), the first connecting portion, the second connecting portion, and the coupling portion are preferably formed by bending a single metal flat plate. From the viewpoint of decreasing the energy loss, the metal flat plate is preferably formed of at least one metal selected from the group consisting of aluminum, copper, and nickel. Furthermore, the metal flat plate preferably has a thickness of 0.1 mm or more and 2.0 mm or less, and more preferably 0.5 mm or more and 1.5 mm or less.

Next, details of a rectangular electricity storage device according to an embodiment and a method for producing the rectangular electricity storage device will be specifically described with reference to the drawings.

[1] Structure of Rectangular Electricity Storage Device

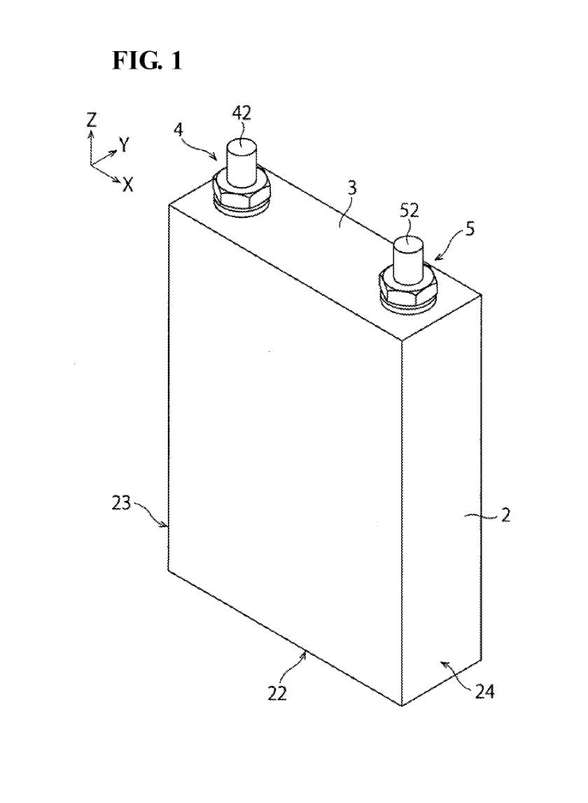

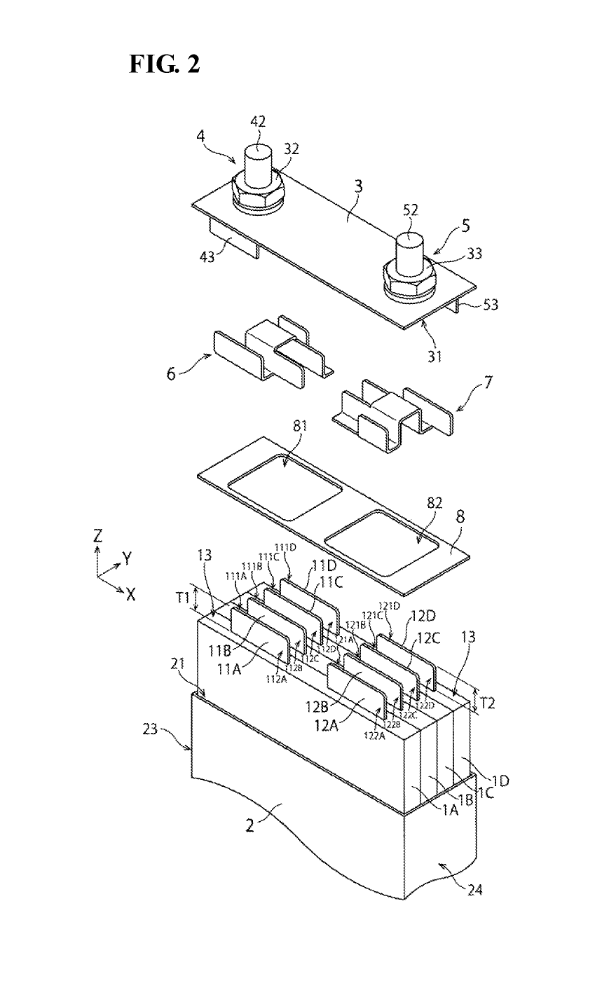

FIG. 1 is a perspective view that conceptually illustrates a rectangular electricity storage device of the present embodiment. FIG. 2 is an exploded perspective view of the rectangular electricity storage device. The rectangular electricity storage device of the present embodiment includes four electrode groups 1A to 1D, a bottom-closed cylindrical outer package can 2, a cover plate 3, a positive electrode terminal member 4, a negative electrode terminal member 5, a positive electrode connection member 6, a negative electrode connection member 7, and an electric insulation sheet 8. Hereinafter, in the position in which an opening 21 of the outer package can 2 is directed upward (refer to FIG. 2), a width direction of the outer package can 2 is defined as an X-direction, a thickness direction of the outer package can 2 is defined as a Y-direction, and a height direction of the outer package can 2 is defined as a Z-direction. The Z-direction coincides with a direction from a bottom surface 22 of the outer package can 2 to the opening 21.

[1-1] Electrode Group

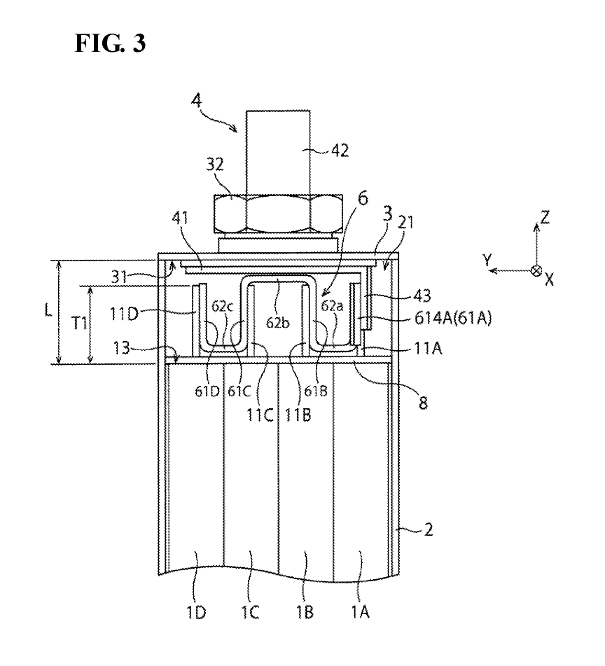

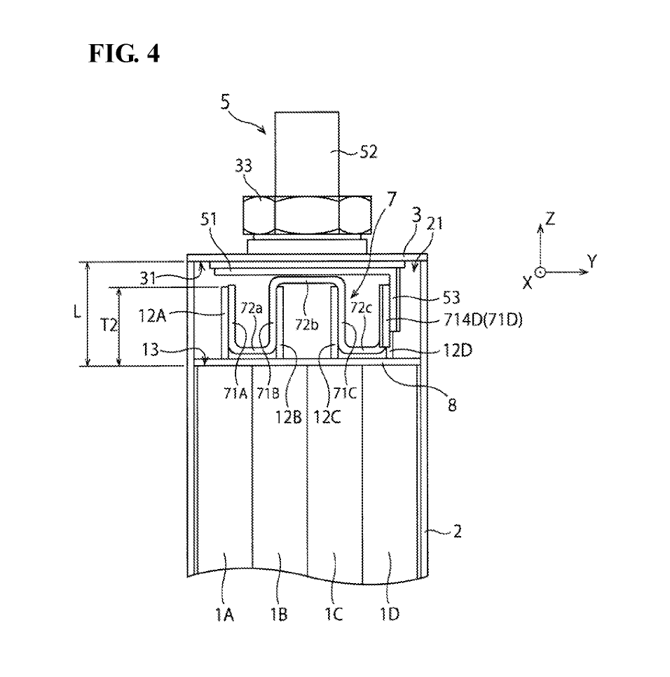

FIG. 3 is a side view illustrating an inner structure (specifically, a connection structure of a positive electrode) of the rectangular electricity storage device, viewed from a first sidewall 23 (refer to FIG. 2) side of the outer package can 2. FIG. 4 is a side view illustrating an inner structure (specifically, a connection structure of a negative electrode) of the rectangular electricity storage device, viewed from a second sidewall 24 (refer to FIG. 2) side of the outer package can 2. As illustrated in FIGS. 2 to 4, the electrode groups 1A to 1D are housed in the outer package can 2 in a state in which the electrode groups 1A to 1D are stacked in the Y-direction. An electrolyte is housed in the outer package can 2 together with the electrode groups 1A to 1D. The electrode groups 1A to 1D each have an end surface 13 facing the opening 21 of the outer package can 2 in the assembled state of the rectangular electricity storage device. The electrode groups 1A to 1D are respectively provided with positive electrode terminal portions 11A to 11D and negative electrode terminal portions 12A to 12D that extend from the end surfaces 13 thereof to the opening 21 (in the Z-direction). In this embodiment, the electrode groups 1A to 1D have the same structure, the same shape, and the same dimensions. The end surfaces 13 of the electrode groups 1A to 1D are flush with each other. Furthermore, a height T1 (refer to FIGS. 2 and 3) of each of the positive electrode terminal portions 11A to 11D from the end surfaces 13, which are flush with each other, with respect to the Z-direction, and a height T2 (refer to FIGS. 2 and 4) of each of the negative electrode terminal portions 12A to 12D from the end surfaces 13 with respect to the Z-direction are all the same.

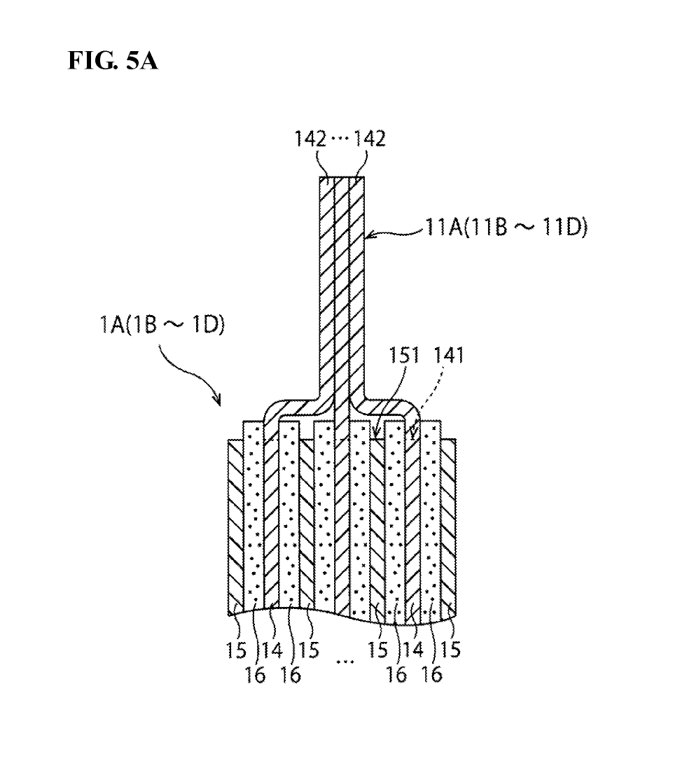

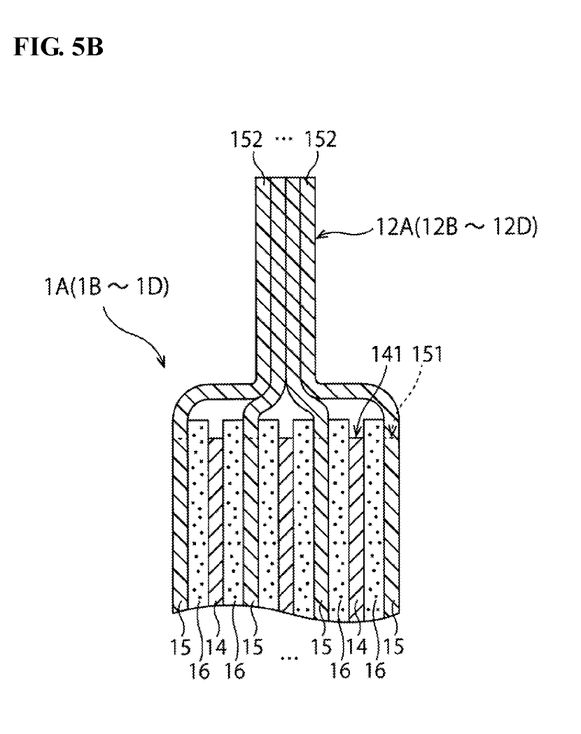

FIG. 5A is a longitudinal cross-sectional view that conceptually illustrates a structure of a positive electrode of each of the electrode groups 1A to 1D. FIG. 5B is a longitudinal cross-sectional view that conceptually illustrates a structure of a negative electrode of each of the electrode groups 1A to 1D. As illustrated in FIGS. 5A and 5B, in each of the electrode groups 1A to 1D, a plurality of positive electrode plates 14 and a plurality of negative electrode plates 15 are alternately stacked with separators 16 therebetween. In this embodiment, the number of the negative electrode plates 15 is larger than the number of the positive electrode plates 14 by 1, and two outer layers are each constituted by the negative electrode plate 15. In an example, the number of the positive electrode plates 14 is 30, and the number of the negative electrode plates 15 is 31. The number of the positive electrode plates 14 may be the same as the number of the negative electrode plates 15, one outer layer may be constituted by the positive electrode plate 14, and another outer layer may be constituted by the negative electrode plate 15. Alternatively, the number of the positive electrode plates 14 may be larger than the number of the negative electrode plates 15 by 1, and two outer layers may each be constituted by the positive electrode plate 14.

As illustrated in FIG. 5A, the positive electrode plates 14 are each provided with a positive electrode tab 142 that protrudes from an edge 141 to the opening 21 (in the Z-direction), the edge 141 facing the opening 21 (refer to FIG. 3) of the outer package can 2 in the assembled state of the rectangular electricity storage device. The positive electrode tabs 142 that are provided on the positive electrode plates 14 belonging to each of the electrode groups 1A to 1D project from the same position on the edges 141, overlap, and form a bundle. The bundle formed in this manner constitutes each of positive electrode terminal portions 11A to 11D. Accordingly, as illustrated in FIG. 2, the positive electrode terminal portions 11A to 11D respectively have first surfaces 111A to 111D directed in the Y-direction and second surfaces 112A to 112D directed in a direction opposite to the Y-direction.

In this embodiment, in all the positive electrode plates 14 included in the electrode groups 1A to 1D, the positive electrode tabs 142 are provided at the same position on the edges 141. Accordingly, two positive electrode terminal portions selected from the four positive electrode terminal portions 11A to 11D face each other in any combination thereof. Alternatively, in each of the electrode groups 1A to 1D, the positive electrode tabs 142 may be provided at different positions on the edges 141.

As illustrated in FIG. 5B, the negative electrode plates 15 are each provided with a negative electrode tab 152 that protrudes from an edge 151 to the opening 21 (in the Z-direction), the edge 151 facing the opening 21 (refer to FIG. 3) of the outer package can 2 in the assembled state of the rectangular electricity storage device. The negative electrode tabs 152 that are provided on the negative electrode plates 15 belonging to each of the electrode groups 1A to 1D project from the same position on the edges 151, overlap, and form a bundle. The bundle formed in this manner constitutes each of negative electrode terminal portions 12A to 12D. Accordingly, as illustrated in FIG. 2, the negative electrode terminal portions 12A to 12D respectively have first surfaces 121A to 121D directed in the Y-direction and second surfaces 122A to 122D directed in a direction opposite to the Y-direction.

In this embodiment, in all the negative electrode plates 15 included in the electrode groups 1A to 1D, the negative electrode tabs 152 are provided at the same position on the edges 151. Accordingly, two negative electrode terminal portions selected from the four negative electrode terminal portions 12A to 12D face each other in any combination thereof. Alternatively, in each of the electrode groups 1A to 1D, the negative electrode tabs 152 may be provided at different positions on the edges 151.

[1-2] Electric Insulation Sheet

The electric insulation sheet 8 is a sheet that prevents a positive electrode and a negative electrode from being electrically short-circuited in the outer package can 2. Specifically, the electric insulation sheet 8 has an outer peripheral shape that is the same as or slightly smaller than the shape of the opening 21 of the outer package can 2. As illustrated in FIG. 2, two windows 81 and 82 are formed in the electric insulation sheet 8. All the positive electrode terminal portions 11A to 11D are allowed to pass through the window 81, and all the negative electrode terminal portions 12A to 12D are allowed to pass through the window 82. In this state, the electric insulation sheet 8 covers the end surfaces 13 of the electrode groups 1A to 1D.

[1-3] Cover Plate

As illustrated in FIG. 3, the opening 21 of the outer package can 2 is sealed by the cover plate 3. Specifically, the cover plate 3 has an outer peripheral shape slightly larger than the shape of the opening 21 of the outer package can 2 and is fixed to an opening end surface of the outer package can 2 by welding means such as laser welding. The opening 21 of the outer package can 2 is preferably hermetically sealed by the cover plate 3 in this manner. This structure prevents a liquid from leaking from the rectangular electricity storage device and prevents foreign materials from entering the rectangular electricity storage device.

[1-4] Positive Electrode Terminal Member and Negative Electrode Terminal Member

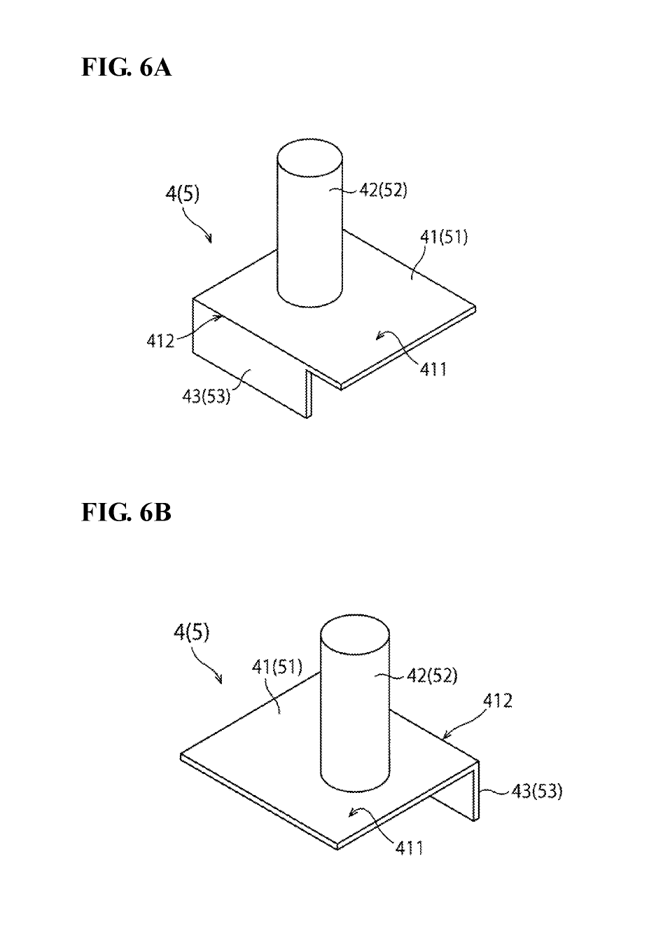

FIGS. 6A and 6B are perspective views that illustrate structures of a positive electrode terminal member 4 and a negative electrode terminal member 5, viewed from directions opposite to each other. As illustrated in FIGS. 6A and 6B, the positive electrode terminal member 4 includes a positive electrode base portion 41, a positive electrode external terminal 42, and a positive electrode projecting portion 43. The positive electrode base portion 41 is a rectangular flat plate. The positive electrode external terminal 42 is a bolt with a thread groove (not illustrated) and is provided to protrude from a main surface 411 of the positive electrode base portion 41. The positive electrode projecting portion 43 is formed on an edge 412 of the positive electrode base portion 41 and electrically connected to the positive electrode external terminal 42 through the positive electrode base portion 41. In this embodiment, the positive electrode projecting portion 43 is provided to be perpendicular to the main surface 411 of the positive electrode base portion 41 and evenly extends along the edge 412 of the positive electrode base portion 41. The positive electrode projecting portion 43 may be slightly inclined with respect to the perpendicular of the main surface 411 of the positive electrode base portion 41. The shape of the positive electrode projecting portion 43 is not limited to a flat shape and may be another shape such as a rod-like shape.

The negative electrode terminal member 5 includes a negative electrode base portion 51, a negative electrode external terminal 52, and a negative electrode projecting portion 53. In this embodiment, the negative electrode terminal member 5 has the same shape and dimensions as the positive electrode terminal member 4. The negative electrode terminal member 5 may have a shape and dimensions that are different from those of the positive electrode terminal member 4.

As illustrated in FIG. 2, the positive electrode terminal member 4 and the negative electrode terminal member 5 are provided on the cover plate 3. Specifically, the positive electrode terminal member 4 is fixed to the cover plate 3 as illustrated in FIG. 3. That is, the positive electrode external terminal 42 passes through the cover plate 3 from an inner surface 31 side of the cover plate 3, and a nut 32 is fitted to the positive electrode external terminal 42 in this state. The nut 32 is tightened toward a base of the positive electrode external terminal 42. With this structure, the positive electrode base portion 41 is fixed to the cover plate 3 while being pressed against the inner surface 31 of the cover plate 3. As a result, the positive electrode terminal member 4 is fixed to the cover plate 3. In this fixed state, the positive electrode projecting portion 43 extends from the inner surface 31 of the cover plate 3 toward the bottom surface 22 of the outer package can 2 (in a direction opposite to the Z-direction). In this embodiment, the positive electrode projecting portion 43 is directed in a direction opposite to the Y-direction with respect to the positive electrode external terminal 42.

As illustrated in FIG. 4, the negative electrode terminal member 5 is fixed to the cover plate 3 similarly to the positive electrode terminal member 4. That is, the negative electrode external terminal 52 passes through the cover plate 3 from the inner surface 31 side of the cover plate 3, and a nut 33 is fitted to the negative electrode external terminal 52 in this state. However, in this embodiment, the negative electrode projecting portion 53 is directed, with respect to the negative electrode external terminal 52, in a direction (Y-direction) opposite to the direction in which the positive electrode projecting portion 43 is directed.

Herein, the positive electrode base portion 41 and the positive electrode projecting portion 43 have such shapes and dimensions that the positive electrode projecting portion 43 can face a non-facing part 614A of a positive electrode connecting portion 61A included in a positive electrode connection member 6 described below (refer to FIG. 3) in the assembled state of the rectangular electricity storage device. The negative electrode base portion 51 and the negative electrode projecting portion 53 have such shapes and dimensions that the negative electrode projecting portion 53 can face a non-facing part 714D of a negative electrode connecting portion 71D included in a negative electrode connection member 7 described below (refer to FIG. 4) in the assembled state of the rectangular electricity storage device.

[1-5] Positive Electrode Connection Member and Negative Electrode Connection Member

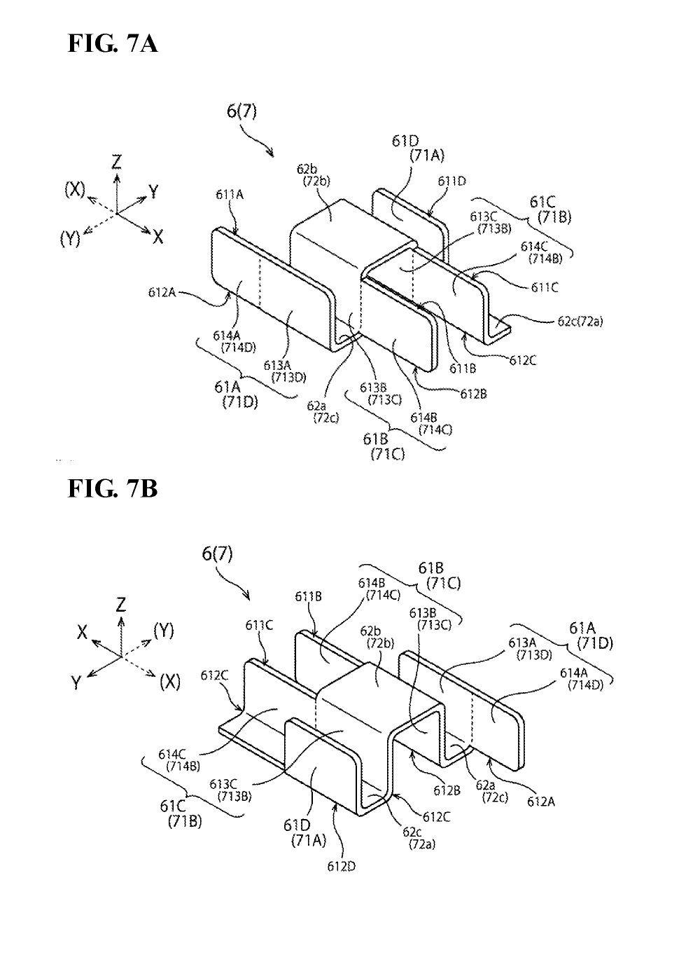

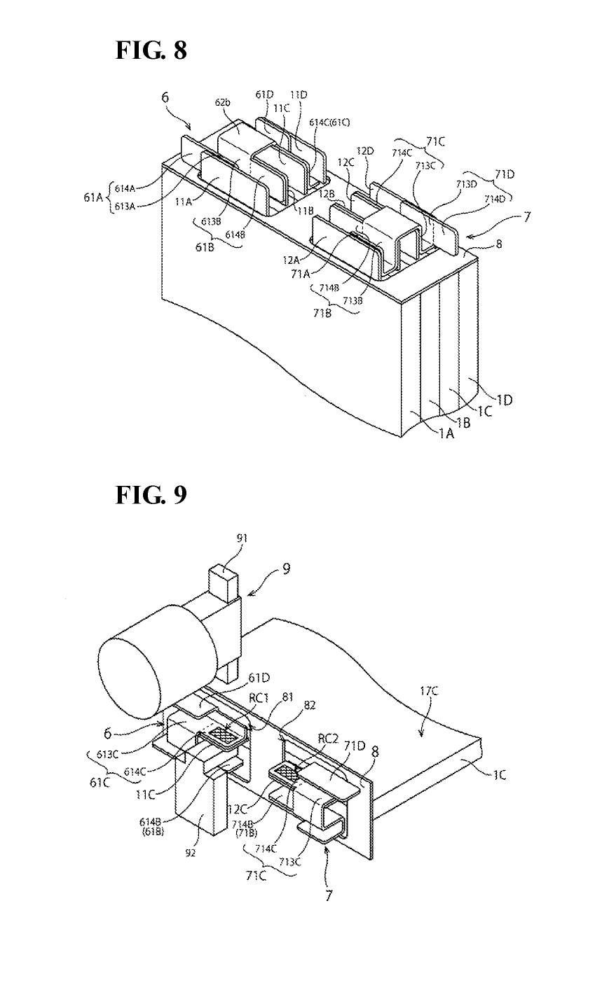

FIGS. 7A and 7B are perspective views that illustrate structures of a positive electrode connection member 6 and a negative electrode connection member 7, viewed from directions opposite to each other. FIG. 8 is a perspective view illustrating a state in which the positive electrode connection member 6 and the negative electrode connection member 7 are connected to the electrode groups 1A to 1D. As illustrated in FIG. 8, the positive electrode connection member 6 and the negative electrode connection member 7 are each a member that mechanically and electrically couples the four electrode groups 1A to 1D to each other, the electrode groups 1A to 1D being housed in the outer package can 2. Each of the positive electrode connection member 6 and the negative electrode connection member 7 is preferably formed of at least one metal selected from the group consisting of aluminum, copper, and nickel.

<Positive Electrode Connection Member>

As illustrated in FIGS. 7A and 7B, the positive electrode connection member 6 includes four positive electrode connecting portions 61A to 61D and three positive electrode coupling portions 62a to 62c. The positive electrode connection member 6 is formed by bending a single metal flat plate having a particular shape. Accordingly, the positive electrode connecting portions 61A to 61D and the positive electrode coupling portions 62a to 62c each have a flat shape. Specifically, the positive electrode connecting portions 61A to 61D have a flat shape parallel to the X-Z plane and sequentially arranged in the Y-direction. The positive electrode coupling portions 62a to 62c have a flat shape parallel to the X-Y plane. The metal flat plate used for forming the positive electrode connection member 6 preferably has a thickness of 0.5 mm or more and 1.5 mm or less.

The positive electrode connecting portion 61A includes a facing part 613A that faces a part of the positive electrode connecting portion 61B, and a non-facing part 614A that extends from the facing part 613A to a lateral side (in a direction opposite to the X-direction) and that does not face the positive electrode connecting portion 61B. The positive electrode connecting portion 61B includes a facing part 613B that faces the positive electrode connecting portion 61A and a non-facing part 614B that does not face the positive electrode connecting portion 61A. The whole of the positive electrode connecting portion 61C faces the positive electrode connecting portion 61B. The positive electrode connecting portion 61D faces a part of the positive electrode connecting portion 61C. The positive electrode connecting portion 61C includes a facing part 613C that faces the positive electrode connecting portion 61D and a non-facing part 614C that does not face the positive electrode connecting portion 61D. In this embodiment, the widths of the positive electrode connecting portions 61B and 61C with respect to the X-direction are substantially the same as the widths of the positive electrode terminal portions 11B and 11C with respect to the X-direction, respectively. The widths of the positive electrode connecting portions 61A to 61D with respect to the Z-direction are respectively smaller than the height T1 of the positive electrode terminal portions 11A to 11D from the end surfaces 13 of the electrode groups 1A to 1D (refer to FIG. 3).

The positive electrode connecting portions 61A to 61D respectively have first edges 611A to 611D that face the opening 21 (refer to FIG. 3) of the outer package can 2, and second edges 612A to 612D disposed on the opposite side of the opening 21 in the assembled state of the rectangular electricity storage device. The second edge 612A of the positive electrode connecting portion 61A is mechanically and electrically coupled to the second edge 612B of the positive electrode connecting portion 61B with the positive electrode coupling portion 62a therebetween. The second edge 612C of the positive electrode connecting portion 61C is mechanically and electrically coupled to the second edge 612D of the positive electrode connecting portion 61D with the positive electrode coupling portion 62c therebetween.

Furthermore, the first edge 611B of the positive electrode connecting portion 61B is mechanically and electrically coupled to the first edge 611C of the positive electrode connecting portion 61C with the positive electrode coupling portion 62b therebetween. Specifically, the facing part 613B of the positive electrode connecting portion 61B is mechanically and electrically coupled to the facing part 613C of the positive electrode connecting portion 61C with the positive electrode coupling portion 62b therebetween. Accordingly, each of the first edges 611B and 611C has a coupled region to which the positive electrode coupling portion 62b is directly coupled and an exposed region to which the positive electrode coupling portion 62b is not coupled.

As illustrated in FIG. 8 (also refer to FIG. 2), the positive electrode connection member 6 is arranged in the following positional relationship with respect to the positive electrode terminal portions 11A to 11D. Specifically, the whole of the positive electrode connecting portion 61B faces the second surface 112B of the positive electrode terminal portion 11B. The whole of the positive electrode connecting portion 61C faces the first surface 111C of the positive electrode terminal portion 11C. The facing part 613A of the positive electrode connecting portion 61A faces a part of the first surface 111A of the positive electrode terminal portion 11A. The whole of the positive electrode connecting portion 61D faces a part of the second surface 112D of the positive electrode terminal portion 11D. Herein, as illustrated in FIG. 3, the positive electrode coupling portions 62a to 62c each have such dimensions that the positive electrode connection member 6 can be arranged with respect to the positive electrode terminal portions 11A to 11D without deforming the positive electrode terminal portions 11A to 11D or with a small amount of deformation of the positive electrode terminal portions 11A to 11D.

In this arrangement relationship, the positive electrode connection member 6 is welded to the positive electrode terminal portions 11A to 11D as follows (refer to FIGS. 2 and 8). Specifically, the positive electrode connecting portion 61A is welded to the first surface 111A of the positive electrode terminal portion 11A in the facing part 613A thereof. The positive electrode connecting portion 61B is welded to the second surface 112B of the positive electrode terminal portion 11B in the non-facing part 614B thereof (in this embodiment, the non-facing part 614B is a part close to the exposed region of the first edge 611B). In other words, the first surface 111A of the positive electrode terminal portion 11A and the second surface 112B of the positive electrode terminal portion 11B are surfaces that face each other, and the positive electrode connecting portions 61A and 61B are respectively welded to the first surface 111A and the second surface 112B.

The positive electrode connecting portion 61C is welded to the first surface 111C of the positive electrode terminal portion 11C in the non-facing part 614C thereof (in this embodiment, the non-facing part 614C is a part close to the exposed region of the first edge 611C). From the viewpoint of the relationship with the positive electrode connecting portion 61B, this structure is understood as follows. Specifically, the second surface 112B of the positive electrode terminal portion 11B and the first surface 111C of the positive electrode terminal portion 11C are respectively back surfaces of the first surface 111B of the positive electrode terminal portion 11B and the second surface 112C of the positive electrode terminal portion 11C, the first surface 111B and the second surface 112C facing each other. The positive electrode connecting portions 61B and 61C are respectively welded to the second surface 112B and the first surface 111C.

The positive electrode connecting portion 61D is welded to the second surface 112D of the positive electrode terminal portion 11D. From the viewpoint of the relationship with the positive electrode connecting portion 61C, this structure is understood as follows. Specifically, the first surface 111C of the positive electrode terminal portion 11C and the second surface 112D of the positive electrode terminal portion 11D are surfaces that face each other, and the positive electrode connecting portions 61C and 61D are respectively welded to the first surface 111C and the second surface 112D.

Furthermore, as illustrated in FIG. 3, the positive electrode connecting portion 61A is welded to the positive electrode projecting portion 43 in the non-facing part 614A thereof. In this manner, the positive electrode plates 14 included in each of the electrode groups 1A to 1D are electrically connected to the positive electrode external terminal 42 through the positive electrode connection member 6.

<Negative Electrode Connection Member>

As illustrated in FIGS. 7A and 7B, the negative electrode connection member 7 includes four negative electrode connecting portions 71A to 71D and three negative electrode coupling portions 72a to 72c. Similarly to the positive electrode connection member 6, the negative electrode connection member 7 is formed by bending a single metal flat plate having a particular shape. Accordingly, the negative electrode connecting portions 71A to 71D and the negative electrode coupling portions 72a to 72c each have a flat shape. Specifically, the negative electrode connecting portions 71A to 71D have a flat shape parallel to the X-Z plane and sequentially arranged in the Y-direction. The negative electrode coupling portions 72a to 72c have a flat shape parallel to the X-Y plane. The metal flat plate used for forming the negative electrode connection member 7 preferably has a thickness of 0.5 mm or more and 1.5 mm or less.

In this embodiment, the negative electrode connection member 7 has the same shape and the same dimensions as the positive electrode connection member 6. The negative electrode connecting portion 71A corresponds to the positive electrode connecting portion 61D. The negative electrode connecting portion 71B corresponds to the positive electrode connecting portion 61C. The negative electrode connecting portion 71C corresponds to the positive electrode connecting portion 61B. The negative electrode connecting portion 71D corresponds to the positive electrode connecting portion 61A. The negative electrode coupling portion 72a corresponds to the positive electrode coupling portion 62c. The negative electrode coupling portion 72b corresponds to the positive electrode coupling portion 62b. The negative electrode coupling portion 72c corresponds to the positive electrode coupling portion 62a. The negative electrode connection member 7 may have a shape and dimensions different from those of the positive electrode connection member 6. Modifications relating to the shape of the negative electrode connection member 7 and the positive electrode connection member 6 will be described below.

As illustrated in FIG. 8 (also refer to FIG. 2), the negative electrode connection member 7 is arranged in the following positional relationship with respect to the negative electrode terminal portions 12A to 12D. Specifically, the whole of the negative electrode connecting portion 71B faces the second surface 122B of the negative electrode terminal portion 12B. The whole of the negative electrode connecting portion 71C faces the first surface 121C of the negative electrode terminal portion 12C. The whole of the negative electrode connecting portion 71A faces a part of the first surface 121A of the negative electrode terminal portion 12A. A facing part 713D of the negative electrode connecting portion 71D faces a part of the second surface 122D of the negative electrode terminal portion 12D. Herein, as illustrated in FIG. 4, the negative electrode coupling portions 72a to 72c each have such dimensions that the negative electrode connection member 7 can be arranged with respect to the negative electrode terminal portions 12A to 12D without deforming the negative electrode terminal portions 12A to 12D or with a small amount of deformation of the negative electrode terminal portions 12A to 12D.

In this arrangement relationship, the negative electrode connection member 7 is welded to the negative electrode terminal portions 12A to 12D as follows (refer to FIGS. 2 and 8). Specifically, the negative electrode connecting portion 71A is welded to the first surface 121A of the negative electrode terminal portion 12A. The negative electrode connecting portion 71B is welded to the second surface 122B of the negative electrode terminal portion 12B in a non-facing part 714B thereof. In other words, the first surface 121A of the negative electrode terminal portion 12A and the second surface 122B of the negative electrode terminal portion 12B are surfaces that face each other, and the negative electrode connecting portions 71A and 71B are respectively welded to the first surface 121A and the second surface 122B.

The negative electrode connecting portion 71C is welded to the first surface 121C of the negative electrode terminal portion 12C in a non-facing part 714C thereof. From the viewpoint of the relationship with the negative electrode connecting portion 71B, this structure is understood as follows. Specifically, the second surface 122B of the negative electrode terminal portion 12B and the first surface 121C of the negative electrode terminal portion 12C are respectively back surfaces of the first surface 121B of the negative electrode terminal portion 12B and the second surface 122C of the negative electrode terminal portion 12C, the first surface 121B and the second surface 122C facing each other. The negative electrode connecting portions 71B and 71C are respectively welded to the second surface 122B and the first surface 121C.

The negative electrode connecting portion 71D is welded to the second surface 122D of the negative electrode terminal portion 12D in the facing part 713D thereof. From the viewpoint of the relationship with the negative electrode connecting portion 71C, this structure is understood as follows. Specifically, the first surface 121C of the negative electrode terminal portion 12C and the second surface 122D of the negative electrode terminal portion 12D are surfaces that face each other, and the negative electrode connecting portions 71C and 71D are respectively welded to the first surface 121C and the second surface 122D.

Furthermore, as illustrated in FIG. 4, the negative electrode connecting portion 71D is welded to the negative electrode projecting portion 53 in the non-facing part 714D thereof. In this manner, the negative electrode plates 15 included in each of the electrode groups 1A to 1D are electrically connected to the negative electrode external terminal 52 through the negative electrode connection member 7.

According to the rectangular electricity storage device of the present embodiment, in a process for producing the rectangular electricity storage device as described below, before the electrode groups 1A to 1D are housed in the outer package can 2, the electrode groups 1A to 1D can be integrated by being fixed to the positive electrode connection member 6 and the negative electrode connection member 7 in a state in which the electrode groups 1A to 1D are stacked. The positive electrode connection member 6 and the negative electrode connection member 7 are each formed by bending a single metal flat plate and thus have high mechanical strength. Therefore, misalignment is unlikely to occur in the electrode groups 1A to 1D which are fixed to the positive electrode connection member 6 and the negative electrode connection member 7 having high mechanical strength.

Accordingly, even before the electrode groups 1A to 1D are housed in the outer package can 2, the positive electrode projecting portion 43 and the negative electrode projecting portion 53 that are fixed to the cover plate 3 can be welded to the positive electrode connection member 6 and the negative electrode connection member 7, respectively, without causing misalignment of the electrode groups 1A to 1D. Thus, the cover plate 3 is fixed to the electrode groups 1A to 1D. The positive electrode plates 14 included in each of the electrode groups 1A to 1D are electrically connected to the positive electrode external terminal 42 through the positive electrode connection member 6. The negative electrode plates 15 included in each of the electrode groups 1A to 1D are electrically connected to the negative electrode external terminal 52 through the negative electrode connection member 7. Even after welding of the cover plate 3, misalignment does not substantially occur in the electrode groups 1A to 1D, and thus the electrode groups 1A to 1D can be housed in the outer package can 2.

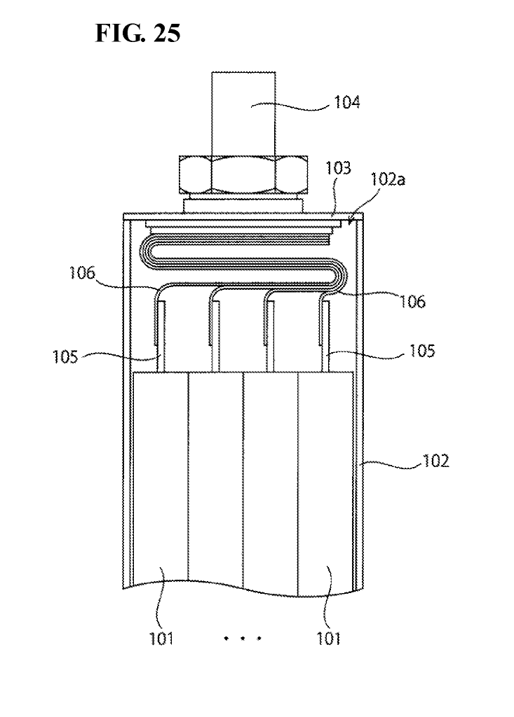

Therefore, the rectangular electricity storage device of the present embodiment does not require the space for housing lead plates that are folded, the space being necessary for the existing rectangular electricity storage device (refer to FIG. 25). Consequently, the ratio of the total volume of the electrode groups 1A to 1D to the volume of the rectangular electricity storage device increases, resulting in an improvement in the volume energy density. From the viewpoint of improving the volume energy, a ratio of the height T1 of the positive electrode terminal portions 11A to 11D or the height T2 of the negative electrode terminal portions 12A to 12D (T2=T1 in the present embodiment) to a distance L from the end surfaces 13 of the electrode groups 1A to 1D, the end surfaces 13 being flush with each other, to the inner surface 31 of the cover plate 3 (refer to FIG. 3 or 4) is preferably 0.9 or less.

In the existing rectangular electricity storage device, the thickness of each lead plate must be small in order to prevent breakage and damage from occurring in a folded portion of the lead plate. In contrast, in the rectangular electricity storage device of the present embodiment, since such breakage and damage do not occur in the positive electrode connection member 6 and the negative electrode connection member 7, each of the positive electrode connection member 6 and the negative electrode connection member 7 can have a large thickness. Even when the positive electrode connection member 6 and the negative electrode connection member 7 each have a large thickness, the volume energy density does not significantly decrease.

Therefore, according to the rectangular electricity storage device of the present embodiment, the electrical resistance of the positive electrode connection member 6 is low, and an energy loss between the positive electrode external terminal 42 and the electrode groups 1A to 1D is decreased. Similarly, the electrical resistance of the negative electrode connection member 7 is low, and an energy loss between the negative electrode external terminal 52 and the electrode groups 1A to 1D is decreased. From the viewpoint of decreasing the energy loss, each of the positive electrode connection member 6 and the negative electrode connection member 7 is preferably formed of at least one metal selected from the group consisting of aluminum, copper, and nickel. The thickness of each of the positive electrode connection member 6 and the negative electrode connection member 7 is preferably 0.5 mm or more and 1.5 mm or less.

[2] Method for Producing Rectangular Electricity Storage Device

In a method for producing the rectangular electricity storage device of the present embodiment, a preparation step, a first welding step, a second welding step, and a sealing step are sequentially performed. In the first welding step, steps (A) to (D) are sequentially performed, and in the second welding step, steps (E) and (F) are sequentially performed. Hereinafter, in the assembled state of the rectangular electricity storage device illustrated in FIG. 2, the surfaces of the electrode groups 1A to 1D that are to be directed in the Y-direction are respectively referred to as first surfaces 17A to 17D, and the surfaces of the electrode groups 1A to 1D that are to be directed in a direction opposite to the Y-direction are respectively referred to as second surfaces 18A to 18D.

[2-1] Preparation Step

First, in the preparation step, a positive electrode connection member 6 and a negative electrode connection member 7 are prepared (refer to FIGS. 7A and 7B). Specifically, the positive electrode connection member 6 is formed by preparing a metal flat plate punched to have a particular shape, and bending the metal flat plate. The negative electrode connection member 7 having the same shape and the same dimensions as the positive electrode connection member 6 is formed by the same method. The negative electrode connection member 7 may have a shape and dimensions different from the positive electrode connection member 6. The metal flat plate used for forming the positive electrode connection member 6 and the negative electrode connection member 7 is preferably formed of at least one metal selected from the group consisting of aluminum, copper, and nickel. The metal flat plate preferably has a thickness of 0.5 mm or more and 1.5 mm or less.

In the preparation step, besides the positive electrode connection member 6 and the negative electrode connection member 7, electrode groups 1A to 1D that respectively include positive electrode terminal portions 11A to 11D and negative electrode terminal portions 12A to 12D, an outer package can 2 in which the electrode groups 1A to 1D are to be housed, a cover plate 3 for sealing an opening 21 of the outer package can 2, and an electric insulation sheet 8 are prepared. A positive electrode terminal member 4 and a negative electrode terminal member 5 are fixed to the cover plate 3 using nuts 32 and 33, respectively.

[2-2] First Welding Step

<Step (A)>

FIG. 9 is a perspective view used for illustrating the step (A) included in the first welding step. As illustrated in FIG. 9, in the step (A), first, the electrode group 1C is arranged so that the positive electrode terminal portion 11C and the negative electrode terminal portion 12C provided on the electrode group 1C are directed in the horizontal direction, and the first surface 17C of the electrode group 1C is directed upward. The electric insulation sheet 8 is arranged in a state in which the positive electrode terminal portion 11C and the negative electrode terminal portion 12C are respectively passed through windows 81 and 82 formed in the electric insulation sheet 8.

Next, the positive electrode connection member 6 is arranged so that the whole of the positive electrode connecting portion 61C faces an upper surface (the first surface 111C illustrated in FIG. 2) of the positive electrode terminal portion 11C. Subsequently, a non-facing part 614C of the positive electrode connecting portion 61C and the positive electrode terminal portion 11C are brought into contact with each other, and ultrasonic welding is performed on the contact surface, thereby joining the non-facing part 614C and the positive electrode terminal portion 11C to each other by welding. Specifically, an ultrasonic welder 9 including a horn 91 that generates ultrasonic waves and an anvil 92 that serves as a pedestal is prepared. The anvil 92 is inserted between a non-facing part 614B of a positive electrode connecting portion 61B and the non-facing part 614C of the positive electrode connecting portion 61C, and the horn 91 is arranged above the non-facing part 614C of the positive electrode connecting portion 61C. Subsequently, the horn 91 is lowered to bring a leading end surface of the horn 91 into contact with a predetermined region RC1 of the non-facing part 614C and to sandwich the non-facing part 614C and the positive electrode terminal portion 11C from the top and the bottom with the horn 91 and the anvil 92. In this state, ultrasonic waves are generated from the horn 91, thereby joining the non-facing part 614C and the positive electrode terminal portion 11C to each other by welding.

In the positive electrode connection member 6 of the present embodiment, the positive electrode connecting portion 61D does not face the non-facing part 614C of the positive electrode connecting portion 61C. Therefore, while it is difficult to bring the horn 91 into contact with the facing part 613C of the positive electrode connecting portion 61C from above the facing part 613C because of the presence of the positive electrode connecting portion 61D, the horn 91 can be easily brought into contact with the non-facing part 614C of the positive electrode connecting portion 61C by lowering the horn 91 from above the non-facing part 614C. Accordingly, a horn having a shape the same as an existing horn can be used as the horn 91. Furthermore, in the positive electrode connection member 6 of the present embodiment, a region (exposed region) serving as an edge of the non-facing part 614B of the first edge 611B and a region (exposed region) serving as an edge of the non-facing part 614C of the first edge 611C are not coupled with a positive electrode coupling portion 62b but are exposed (refer to FIGS. 7A and 7B). Therefore, the anvil 92 is easily inserted between the non-facing parts 614B and 614C. Accordingly, in the step (A), welding of the positive electrode connecting portion 61C and the positive electrode terminal portion 11C is easily performed.

Furthermore, in the step (A), the negative electrode connection member 7 is arranged so that the whole of the negative electrode connecting portion 71C faces an upper surface (the first surface 121C illustrated in FIG. 2) of the negative electrode terminal portion 12C. Subsequently, a non-facing part 714C of the negative electrode connecting portion 71C and the negative electrode terminal portion 12C are brought into contact with each other, and ultrasonic welding is performed on the contact surface, thereby joining the non-facing part 714C and the negative electrode terminal portion 12C to each other by welding. Specifically, the anvil 92 is inserted between a non-facing part 714B of a negative electrode connecting portion 71B and the non-facing part 714C of the negative electrode connecting portion 71C, and the horn 91 is arranged above the non-facing part 714C of the negative electrode connecting portion 71C. Subsequently, the horn 91 is lowered to bring the leading end surface of the horn 91 into contact with a predetermined region RC2 of the non-facing part 714C and to sandwich the non-facing part 714C and the negative electrode terminal portion 12C from the top and the bottom with the horn 91 and the anvil 92. In this state, ultrasonic waves are generated from the horn 91, thereby joining the non-facing part 714C and the negative electrode terminal portion 12C to each other by welding.

In the negative electrode connection member 7 of the present embodiment, the negative electrode connecting portion 71D does not face the non-facing part 714C of the negative electrode connecting portion 71C. Therefore, while it is difficult to bring the horn 91 into contact with the facing part 713C of the negative electrode connecting portion 71C from above the facing part 713C because of the presence of the negative electrode connecting portion 71D, the horn 91 can be easily brought into contact with the non-facing part 714C of the negative electrode connecting portion 71C by lowering the horn 91 from above the non-facing part 714C. Furthermore, in the negative electrode connection member 7 of the present embodiment, the anvil 92 is easily inserted between the non-facing parts 714B and 714C as in the positive electrode connection member 6. Accordingly, in the step (A), welding of the negative electrode connecting portion 71C and the negative electrode terminal portion 12C is easily performed.

<Step (B)>

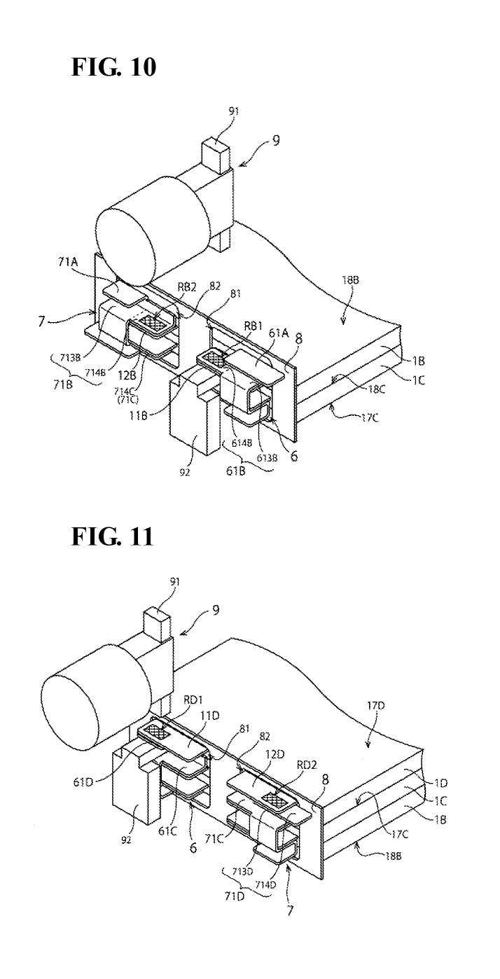

FIG. 10 is a perspective view used for illustrating the step (B) included in the first welding step. As illustrated in FIG. 10, in the step (B), first, the top and the bottom of the electrode group 1C subjected to the step (A) are reversed to direct the first surface 17C of the electrode group 1C downward and to direct the second surface 18C of the electrode group 1C upward. Subsequently, the electrode group 1B is superposed on the second surface 18C of the electrode group 1C so that a second surface 18B of the electrode group 1B is directed upward. At this time, a positive electrode terminal portion 11B and a negative electrode terminal portion 12B provided on the electrode group 1B are respectively passed through the windows 81 and 82 formed in the electric insulation sheet 8. In addition, the upper surface (the second surface 112B illustrated in FIG. 2) of the positive electrode terminal portion 11B is allowed to face the whole of the positive electrode connecting portion 61B. Furthermore, the upper surface (the second surface 122B illustrated in FIG. 2) of the negative electrode terminal portion 12B is allowed to face the whole of the negative electrode connecting portion 71B.

Subsequently, a non-facing part 614B of the positive electrode connecting portion 61B and the positive electrode terminal portion 11B are brought into contact with each other, and ultrasonic welding is performed on the contact surface, thereby joining the non-facing part 614B and the positive electrode terminal portion 11B to each other by welding. Specifically, the anvil 92 is inserted between the non-facing part 614B of the positive electrode connecting portion 61B and the non-facing part 614C (in FIG. 10, the non-facing part 614C is hidden by the anvil 92) of the positive electrode connecting portion 61C, and the horn 91 is arranged above the non-facing part 614B of the positive electrode connecting portion 61B. Subsequently, the horn 91 is lowered to bring the leading end surface of the horn 91 into contact with a predetermined region RB1 of the non-facing part 614B and to sandwich the non-facing part 614B and the positive electrode terminal portion 11B from the top and the bottom with the horn 91 and the anvil 92. In this state, ultrasonic waves are generated from the horn 91, thereby joining the non-facing part 614B and the positive electrode terminal portion 11B to each other by welding.

In the positive electrode connection member 6 of the present embodiment, the positive electrode connecting portion 61A does not face the non-facing part 614B of the positive electrode connecting portion 61B. Therefore, while it is difficult to bring the horn 91 into contact with the facing part 613B of the positive electrode connecting portion 61B from above the facing part 613B because of the presence of the positive electrode connecting portion 61A, the horn 91 can be easily brought into contact with the non-facing part 614B of the positive electrode connecting portion 61B by lowering the horn 91 from above the non-facing part 614B. Furthermore, in the positive electrode connection member 6 of the present embodiment, the exposed region of the first edge 611B and the exposed region of the first edge 611C are not coupled with the positive electrode coupling portion 62b but are exposed as described above. Therefore, the anvil 92 is easily inserted between the non-facing parts 614B and 614C. Accordingly, in the step (B), welding of the positive electrode connecting portion 61B and the positive electrode terminal portion 11B is easily performed.

Furthermore, in the step (B), a non-facing part 714B of the negative electrode connecting portion 71B and the negative electrode terminal portion 12B are brought into contact with each other, and ultrasonic welding is performed on the contact surface, thereby joining the non-facing part 714B and the negative electrode terminal portion 12B to each other by welding. Specifically, the anvil 92 is inserted between the non-facing part 714B of the negative electrode connecting portion 71B and the non-facing part 714C of the negative electrode connecting portion 71C, and the horn 91 is arranged above the non-facing part 714B of the negative electrode connecting portion 71B. Subsequently, the horn 91 is lowered to bring the leading end surface of the horn 91 into contact with a predetermined region RB2 of the non-facing part 714B and to sandwich the non-facing part 714B and the negative electrode terminal portion 12B from the top and the bottom with the horn 91 and the anvil 92. In this state, ultrasonic waves are generated from the horn 91, thereby joining the non-facing part 714B and the negative electrode terminal portion 12B to each other by welding.

In the negative electrode connection member 7 of the present embodiment, the negative electrode connecting portion 71A does not face the non-facing part 714B of the negative electrode connecting portion 71B. Therefore, while it is difficult to bring the horn 91 into contact with the facing part 713B of the negative electrode connecting portion 71B from above the facing part 713B because of the presence of the negative electrode connecting portion 71A, the horn 91 can be easily brought into contact with the non-facing part 714B of the negative electrode connecting portion 71B by lowering the horn 91 from above the non-facing part 714B. Furthermore, in the negative electrode connection member 7 of the present embodiment, the anvil 92 is easily inserted between the non-facing parts 714B and 714C as in the positive electrode connection member 6. Accordingly, in the step (B), welding of the negative electrode connecting portion 71B and the negative electrode terminal portion 12B is easily performed.

<Step (C)>

FIG. 11 is a perspective view used for illustrating the step (C) included in the first welding step. As illustrated in FIG. 11, in the step (C), first, the top and the bottom of the electrode groups 1B and 1C subjected to the step (B) are reversed to direct the second surface 18B of the electrode group 1B downward and to direct the first surface 17C of the electrode group 1C upward. Subsequently, the electrode group 1D is superposed on the first surface 17C of the electrode group 1C so that a first surface 17D of the electrode group 1D is directed upward. At this time, a positive electrode terminal portion 11D and a negative electrode terminal portion 12D provided on the electrode group 1D are respectively passed through the windows 81 and 82 formed in the electric insulation sheet 8. In addition, a part of the lower surface (the second surface 112D illustrated in FIG. 2) of the positive electrode terminal portion 11D is allowed to face the whole of the positive electrode connecting portion 61D. Furthermore, a part of the lower surface (the second surface 122D illustrated in FIG. 2) of the negative electrode terminal portion 12D is allowed to face the facing part 713D of the negative electrode connecting portion 71D.

Subsequently, the positive electrode connecting portion 61D and positive electrode terminal portion 11D are brought into contact with each other, and ultrasonic welding is performed on the contact surface, thereby joining the positive electrode connecting portion 61D and the positive electrode terminal portion 11D to each other by welding. Specifically, the anvil 92 is inserted between the positive electrode connecting portions 61C and 61D, and the horn 91 is arranged above the positive electrode connecting portion 61D. Subsequently, the horn 91 is lowered to bring the leading end surface of the horn 91 into contact with a predetermined region RD1 of the positive electrode terminal portion 11D at a position above the positive electrode connecting portion 61D and to sandwich the positive electrode connecting portion 61D and the positive electrode terminal portion 11D from the top and the bottom with the horn 91 and the anvil 92. In this state, ultrasonic waves are generated from the horn 91, thereby joining the positive electrode connecting portion 61D and the positive electrode terminal portion 11D to each other by welding.

Furthermore, in the step (C), the facing part 713D of the negative electrode connecting portion 71D and the negative electrode terminal portion 12D are brought into contact with each other, and ultrasonic welding is performed on the contact surface, thereby joining the facing part 713D and the negative electrode terminal portion 12D to each other by welding. Specifically, the anvil 92 is inserted between the negative electrode connecting portions 71C and 71D, and the horn 91 is arranged above the facing part 713D of the negative electrode connecting portion 71D. Subsequently, the horn 91 is lowered to bring the leading end surface of the horn 91 into contact with a predetermined region RD2 of the negative electrode terminal portion 12D at a position above the facing part 713D and to sandwich the facing part 713D and the negative electrode terminal portion 12D from the top and the bottom with the horn 91 and the anvil 92. In this state, ultrasonic waves are generated from the horn 91, thereby joining the facing part 713D and the negative electrode terminal portion 12D to each other by welding.

<Step (D)>

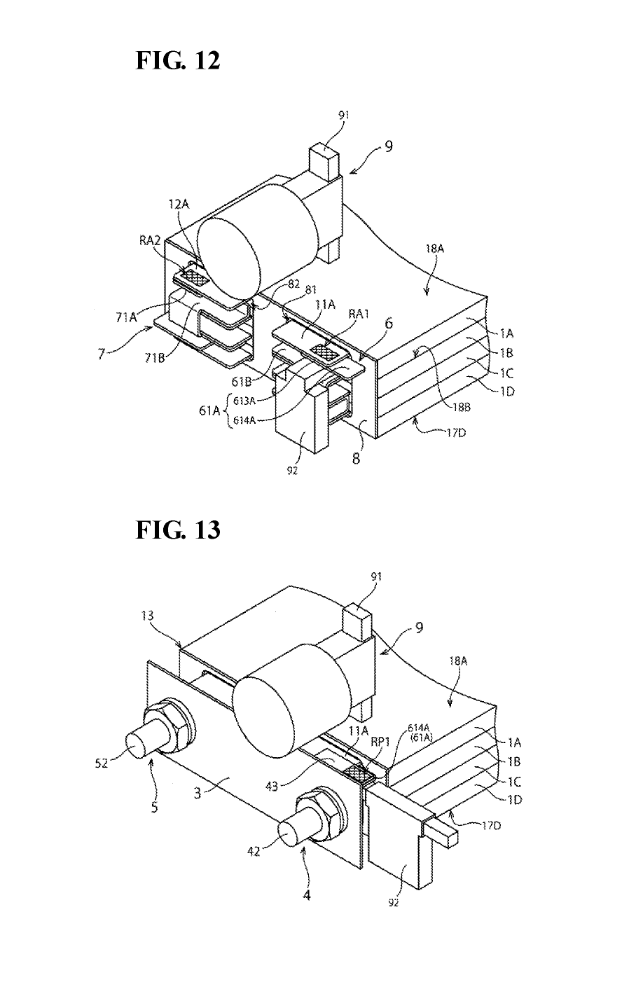

FIG. 12 is a perspective view used for illustrating the step (D) included in the first welding step. As illustrated in FIG. 12, in the step (D), first, the top and the bottom of the electrode groups 1B to 1D subjected to the step (C) are reversed to direct the first surface 17D of the electrode group 1D downward and to direct the second surface 18B of the electrode group 1B upward. Subsequently, the electrode group 1A is superposed on the second surface 18B of the electrode group 1B so that a second surface 18A of the electrode group 1A is directed upward. At this time, a positive electrode terminal portion 11A and a negative electrode terminal portion 12A provided on the electrode group 1A are respectively passed through the windows 81 and 82 formed in the electric insulation sheet 8. In addition, a part of the lower surface (the first surface 111A illustrated in FIG. 2) of the positive electrode terminal portion 11A is allowed to face a facing part 613A of the positive electrode connecting portion 61A. Furthermore, a part of the lower surface (the first surface 121A illustrated in FIG. 2) of the negative electrode terminal portion 12A is allowed to face the whole of the negative electrode connecting portion 71A.

Subsequently, the facing part 613A of the positive electrode connecting portion 61A and the positive electrode terminal portion 11A are brought into contact with each other, and ultrasonic welding is performed on the contact surface, thereby joining the facing part 613A and the positive electrode terminal portion 11A to each other by welding. Specifically, the anvil 92 is inserted between the positive electrode connecting portions 61A and 61B, and the horn 91 is arranged above the facing part 613A of the positive electrode connecting portion 61A. Subsequently, the horn 91 is lowered to bring the leading end surface of the horn 91 into contact with a predetermined region RA1 of the positive electrode terminal portion 11A at a position above the facing part 613A and to sandwich the facing part 613A and the positive electrode terminal portion 11A from the top and the bottom with the horn 91 and the anvil 92. In this state, ultrasonic waves are generated from the horn 91, thereby joining the facing part 613A and the positive electrode terminal portion 11A to each other by welding.

Furthermore, in the step (D), the negative electrode connecting portion 71A and the negative electrode terminal portion 12A are brought into contact with each other, and ultrasonic welding is performed on the contact surface, thereby joining the negative electrode connecting portion 71A and the negative electrode terminal portion 12A to each other by welding. Specifically, the anvil 92 is inserted between the negative electrode connecting portions 71A and 71B, and the horn 91 is arranged above the negative electrode connecting portion 71A. Subsequently, the horn 91 is lowered to bring the leading end surface of the horn 91 into contact with a predetermined region RA2 of the negative electrode terminal portion 12A at a position above the negative electrode connecting portion 71A and to sandwich the negative electrode connecting portion 71A and the negative electrode terminal portion 12A from the top and the bottom with the horn 91 and the anvil 92. In this state, ultrasonic waves are generated from the horn 91, thereby joining the negative electrode connecting portion 71A and the negative electrode terminal portion 12A to each other by welding.

By performing the first welding step (steps (A) to (D)), the four electrode groups 1A to 1D are mechanically and electrically coupled to each other through the positive electrode connection member 6 and the negative electrode connection member 7.

[2-3] Second Welding Step

<Step (E)>

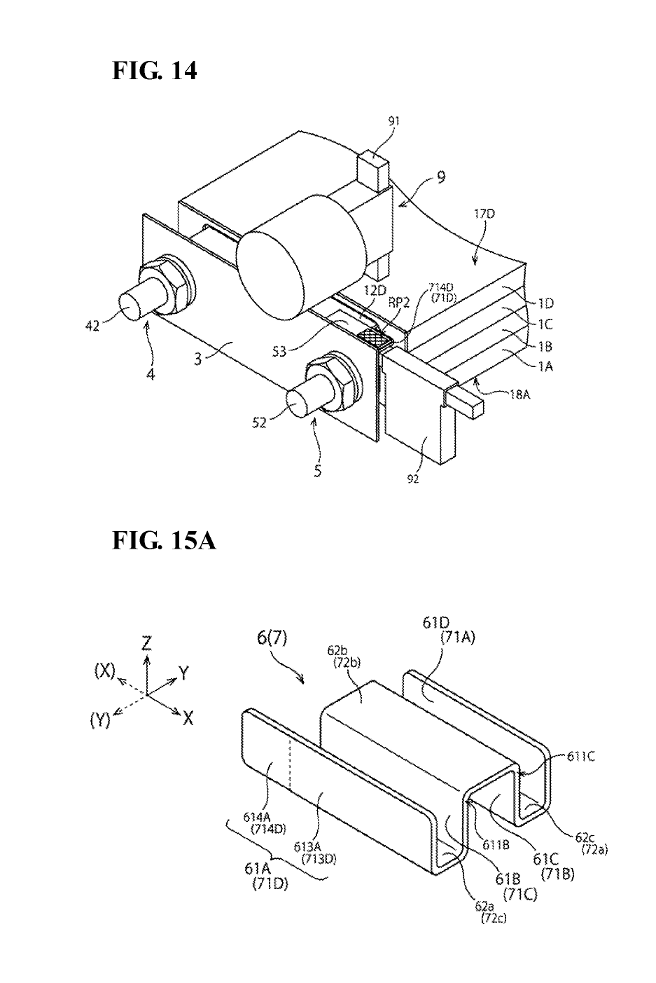

FIG. 13 is a perspective view used for illustrating the step (E) included in the second welding step. As illustrated in FIG. 13, in the step (E), first, a cover plate 3 to which a positive electrode terminal member 4 and a negative electrode terminal member 5 are fixed is arranged as follows with respect to the electrode groups 1A to 1D subjected to the step (D). Specifically, in a state in which a positive electrode external terminal 42 and a negative electrode external terminal 52 are located on the side opposite to an end surface 13 of the electrode groups 1A to 1D, a positive electrode projecting portion 43 is superposed on a non-facing part 614A of the positive electrode connecting portion 61A (refer to FIG. 13), and a negative electrode projecting portion 53 is superposed on a non-facing part 714D of the negative electrode connecting portion 71D (refer to FIG. 14). At this time, a part of the positive electrode projecting portion 43 may overlap with the positive electrode terminal portion 11A. A part of the negative electrode projecting portion 53 may overlap with the negative electrode terminal portion 12D.

Subsequently, the positive electrode projecting portion 43 and the non-facing part 614A of the positive electrode connecting portion 61A are brought into contact with each other, and ultrasonic welding is performed on the contact surface, thereby joining the positive electrode projecting portion 43 and the non-facing part 614A to each other by welding. Specifically, the anvil 92 is arranged below the non-facing part 614A of the positive electrode connecting portion 61A, and the horn 91 is arranged above the positive electrode projecting portion 43. Subsequently, the horn 91 is lowered to bring the leading end surface of the horn 91 into contact with a predetermined region RP1 of the positive electrode projecting portion 43 at a position above the non-facing part 614A and to sandwich the positive electrode projecting portion 43 and the non-facing part 614A from the top and the bottom with the horn 91 and the anvil 92. In this state, ultrasonic waves are generated from the horn 91, thereby joining the positive electrode projecting portion 43 and the non-facing part 614A to each other by welding.

<Step (F)>

FIG. 14 is a perspective view used for illustrating the step (F) included in the second welding step. As illustrated in FIG. 14, in the step (F), first, the top and the bottom of the electrode groups 1A to 1D subjected to the step (E) are reversed to direct the second surface 18A of the electrode group 1A downward and to direct the first surface 17D of the electrode group 1D upward.

Subsequently, the negative electrode projecting portion 53 and the non-facing part 714D of the negative electrode connecting portion 71D are brought into contact with each other, and ultrasonic welding is performed on the contact surface, thereby joining the negative electrode projecting portion 53 and the non-facing part 714D to each other by welding. Specifically, the anvil 92 is arranged below the non-facing part 714D of the negative electrode connecting portion 71D, and the horn 91 is arranged above the negative electrode projecting portion 53. Subsequently, the horn 91 is lowered to bring the leading end surface of the horn 91 into contact with a predetermined region RP2 of the negative electrode projecting portion 53 at a position above the non-facing part 714D and to sandwich the negative electrode projecting portion 53 and the non-facing part 714D from the top and the bottom with the horn 91 and the anvil 92. In this state, ultrasonic waves are generated from the horn 91, thereby joining the negative electrode projecting portion 53 and the non-facing part 714D to each other by welding.

By performing the second welding step (steps (E) and (F)), the positive electrode plates 14 included in each of the electrode groups 1A to 1D are electrically connected to the positive electrode external terminal 42 through the positive electrode connection member 6, and the negative electrode plates 15 included in each of the electrode groups 1A to 1D are electrically connected to the negative electrode external terminal 52 through the negative electrode connection member 7.

[2-4] Sealing Step

After the second welding step is performed, in the sealing step, the electrode groups 1A to 1D and an electrolyte are housed in an outer package can 2, and the cover plate 3 is brought into contact with an opening end surface of the outer package can 2. In this state, welding is performed on the contact surface between the outer package can 2 and the cover plate 3 by welding means such as laser welding to seal an opening 21 of the outer package can 2 with the cover plate 3.

According to the production method of the present embodiment, as described above, a space for housing lead plates that are folded, the space being necessary for the existing rectangular electricity storage device (refer to FIG. 25), is not necessary. Therefore, in a rectangular electricity storage device to be produced, the ratio of the total volume of the electrode groups 1A to 1D to the volume of the device increases, resulting in an improvement in the volume energy density. Furthermore, according to the production method of the present embodiment, the thickness of each of the positive electrode connection member 6 and the negative electrode connection member 7 can be increased. Consequently, the electrical resistance of the positive electrode connection member 6 is low, and an energy loss between the positive electrode external terminal 42 and the electrode groups 1A to 1D is decreased in the rectangular electricity storage device produced. Similarly, the electrical resistance of the negative electrode connection member 7 is low, and an energy loss between the negative electrode external terminal 52 and the electrode groups 1A to 1D is decreased in the rectangular electricity storage device produced.

[3] Modifications

[3-1] First Modification

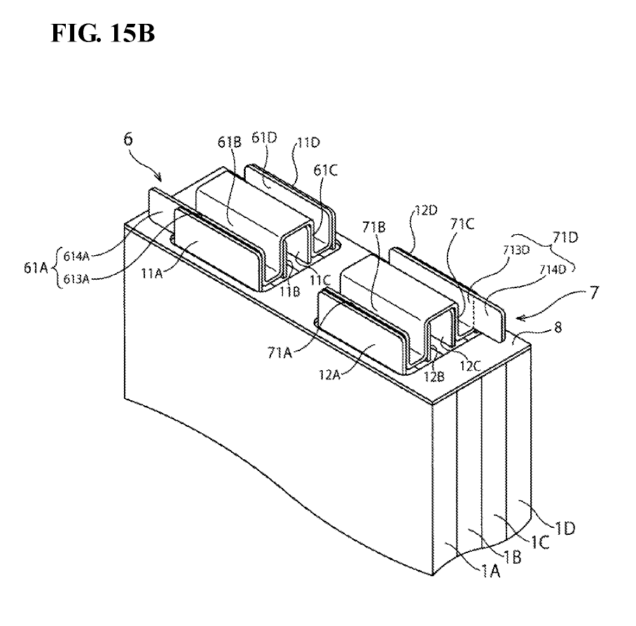

FIG. 15A is a perspective view illustrating a structure of each of a positive electrode connection member 6 and a negative electrode connection member 7 included in a rectangular electricity storage device according to a first modification. FIG. 15B is a perspective view illustrating a state in which the positive electrode connection member 6 and the negative electrode connection member 7 are connected to electrode groups 1A to 1D. The difference from the structure of the rectangular electricity storage device of the above embodiment will be mainly described in detail below.

<Positive Electrode Connection Member>

In the first modification, as illustrated in FIG. 15A, a facing part 613A of a positive electrode connecting portion 61A faces the whole of a positive electrode connecting portion 61B. Regarding a positive electrode connecting portion 61D, the whole of the positive electrode connecting portion 61D faces a positive electrode connecting portion 61C. Furthermore, a positive electrode coupling portion 62b is coupled to the whole of first edges 611B and 611C, and thus each of the first edges 611B and 611C has no exposed region. Other structures are the same as those of the positive electrode connection member 6 illustrated in FIGS. 7A and 7B, and thus a description thereof is omitted.

As illustrated in FIG. 15B (also refer to FIG. 2), the positive electrode connection member 6 is arranged in the following positional relationship with respect to the positive electrode terminal portions 11A to 11D. Specifically, the facing part 613A of the positive electrode connecting portion 61A faces the first surface 111A of the positive electrode terminal portion 11A. The whole of the positive electrode connecting portion 61B faces the second surface 112B of the positive electrode terminal portion 11B. The whole of the positive electrode connecting portion 61C faces the first surface 111C of the positive electrode terminal portion 11C. The whole of the positive electrode connecting portion 61D faces the second surface 112D of the positive electrode terminal portion 11D. Herein, the positive electrode coupling portions 62a to 62c (refer to FIG. 15A) each have such dimensions that the positive electrode connection member 6 can be arranged with respect to the positive electrode terminal portions 11A to 11D without deforming the positive electrode terminal portions 11A to 11D or with a small amount of deformation of the positive electrode terminal portions 11A to 11D.

In this arrangement relationship, the positive electrode connection member 6 is welded to the positive electrode terminal portions 11A to 11D as follows. Specifically, the positive electrode connecting portion 61A is welded to the first surface 111A of the positive electrode terminal portion 11A in the facing part 613A thereof. The positive electrode connecting portion 61B is welded to the second surface 112B of the positive electrode terminal portion 11B. The positive electrode connecting portion 61C is welded to the first surface 111C of the positive electrode terminal portion 11C. The positive electrode connecting portion 61D is welded to the second surface 112D of the positive electrode terminal portion 11D.

Furthermore, the positive electrode connecting portion 61A is welded to the positive electrode projecting portion 43 in a non-facing part 614A thereof (refer to FIG. 3). In this manner, the positive electrode plates 14 included in each of the electrode groups 1A to 1D are electrically connected to the positive electrode external terminal 42 through the positive electrode connection member 6.

<Negative Electrode Connection Member>

In the first modification, the negative electrode connection member 7 has the same shape and the same dimensions as the positive electrode connection member 6. A negative electrode connecting portion 71A corresponds to the positive electrode connecting portion 61D, a negative electrode connecting portion 71B corresponds to the positive electrode connecting portion 61C, a negative electrode connecting portion 71C corresponds to the positive electrode connecting portion 61B, and a negative electrode connecting portion 71D corresponds to the positive electrode connecting portion 61A (refer to FIG. 15A). A negative electrode coupling portion 72a corresponds to the positive electrode coupling portion 62c. A negative electrode coupling portion 72b corresponds to the positive electrode coupling portion 62b. A negative electrode coupling portion 72c corresponds to the positive electrode coupling portion 62a. The negative electrode connection member 7 may have a shape and dimensions different from those of the positive electrode connection member 6.

As illustrated in FIG. 15B (also refer to FIG. 2), the negative electrode connection member 7 is arranged in the following positional relationship with respect to the negative electrode terminal portions 12A to 12D. Specifically, the whole of the negative electrode connecting portion 71A faces the first surface 121A of the negative electrode terminal portion 12A. The whole of the negative electrode connecting portion 71B faces the second surface 122B of the negative electrode terminal portion 12B. The whole of the negative electrode connecting portion 71C faces the first surface 121C of the negative electrode terminal portion 12C. A facing part 713D of the negative electrode connecting portion 71D faces the second surface 122D of the negative electrode terminal portion 12D. Herein, the negative electrode coupling portions 72a to 72c (FIG. 15A) each have such dimensions that the negative electrode connection member 7 can be arranged with respect to the negative electrode terminal portions 12A to 12D without deforming the negative electrode terminal portions 12A to 12D or with a small amount of deformation of the negative electrode terminal portions 12A to 12D.

In this arrangement relationship, the negative electrode connection member 7 is welded to the negative electrode terminal portions 12A to 12D as follows. Specifically, the negative electrode connecting portion 71A is welded to the first surface 121A of the negative electrode terminal portion 12A. The negative electrode connecting portion 71B is welded to the second surface 122B of the negative electrode terminal portion 12B. The negative electrode connecting portion 71C is welded to the first surface 121C of the negative electrode terminal portion 12C. The negative electrode connecting portion 71D is welded to the second surface 122D of the negative electrode terminal portion 12D in the facing part 713D thereof

Furthermore, the negative electrode connecting portion 71D is welded to the negative electrode projecting portion 53 in a non-facing part 714D thereof (refer to FIG. 4). In this manner, the negative electrode plates 15 included in each of the electrode groups 1A to 1D are electrically connected to the negative electrode external terminal 52 through the negative electrode connection member 7.

According to the rectangular electricity storage device of the first modification, as in the rectangular electricity storage device of the embodiment described above, even before the electrode groups 1A to 1D are housed in the outer package can 2, the positive electrode projecting portion 43 and the negative electrode projecting portion 53 that are fixed to the cover plate 3 can be welded to the positive electrode connection member 6 and the negative electrode connection member 7, respectively, without causing misalignment of the electrode groups 1A to 1D. Accordingly, the rectangular electricity storage device of the first modification does not require the space for housing lead plates that are folded, the space being necessary for the existing rectangular electricity storage device (refer to FIG. 25). Therefore, the ratio of the total volume of the electrode groups 1A to 1D to the volume of the rectangular electricity storage device increases, resulting in an improvement in the volume energy density.

Furthermore, according to the rectangular electricity storage device of the first modification, the thickness of each of the positive electrode connection member 6 and the negative electrode connection member 7 can be increased as in the rectangular electricity storage device of the embodiment described above. Accordingly, the electrical resistance of the positive electrode connection member 6 is low, and an energy loss between the positive electrode external terminal 42 and the electrode groups 1A to 1D is decreased. Similarly, the electrical resistance of the negative electrode connection member 7 is low, and an energy loss between the negative electrode external terminal 52 and the electrode groups 1A to 1D is decreased.

<Method for Producing Rectangular Electricity Storage Device>

In a method for producing the rectangular electricity storage device of the first modification, a preparation step, a first welding step, a second welding step, and a sealing step are sequentially performed. In the first welding step, steps (A′) to (D′) are sequentially performed. Since the preparation step, the second welding step, and the sealing step are the same as those in the above embodiment, a description thereof is omitted. The first welding step will now be described with reference to the drawings.

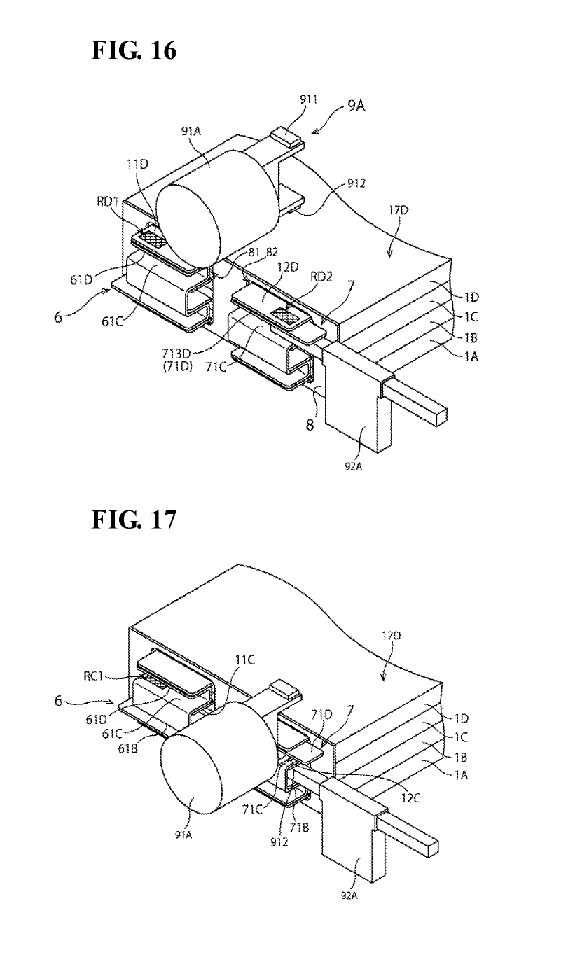

FIG. 16 is a perspective view used for illustrating the step (A′) included in the first welding step. As illustrated in FIG. 16, in the step (A′), first, electrode groups 1A to 1D are stacked so that all positive electrode terminal portions 11A to 11D and negative electrode terminal portions 12A to 12D provided on the electrode groups 1A to 1D are oriented in the same direction. At this time, the electrode groups 1A to 1D are stacked so that the positive electrode terminal portions 11A to 11D face each other and the negative electrode terminal portions 12A to 12D face each other. The electrode groups 1A to 1D are arranged so that the positive electrode terminal portions 11A to 11D and the negative electrode terminal portions 12A to 12D are oriented in the horizontal direction, and a first surface 17D (surface oriented in the Y-direction in the assembled state of the rectangular electricity storage device (refer to FIG. 2)) of the electrode group 1D is oriented upward. Furthermore, an electric insulation sheet 8 is arranged in a state in which the positive electrode terminal portions 11A to 11D and the negative electrode terminal portions 12A to 12D are respectively passed through windows 81 and 82 formed in the electric insulation sheet 8.

Next, the positive electrode connection member 6 is arranged so that the positional relationship becomes the same as the positional relationship illustrated in FIG. 15B with respect to the positive electrode terminal portions 11A to 11D. Subsequently, as illustrated in FIG. 16, the positive electrode connecting portion 61D and the positive electrode terminal portion 11D are brought into contact with each other, and ultrasonic welding is performed on the contact surface, thereby joining the positive electrode connecting portion 61D and the positive electrode terminal portion 11D to each other by welding. For the ultrasonic welding, an ultrasonic welder 9A including a horn 91A that generates ultrasonic waves and an anvil 92A that serves as a pedestal is used. In this modification, the shape of the horn 91A is different from the shape of the horn 91 (refer to, for example, FIG. 9) used in the embodiment described above. The horn 91A includes two upper and lower welding ends that can be inserted between adjacent two positive electrode terminal portions and adjacent two positive electrode connecting portions. Hereinafter, an upper welding end 911 and a lower welding end 912 are referred to as “first welding end 911” and “second welding end 912”, respectively.

Specifically, the anvil 92A is inserted between the positive electrode connecting portions 61C and 61D from the lateral side, and the second welding end 912 of the horn 91A is arranged above the positive electrode connecting portion 61D. Subsequently, the horn 91A is lowered to bring a leading end surface of the second welding end 912 into contact with a predetermined region RD1 of the positive electrode terminal portion 11D at a position above the positive electrode connecting portion 61D and to sandwich the positive electrode connecting portion 61D and the positive electrode terminal portion 11D from the top and the bottom with the horn 91A and the anvil 92A. In this state, ultrasonic waves are generated from the second welding end 912 of the horn 91A, thereby joining the positive electrode connecting portion 61D and the positive electrode terminal portion 11D to each other by welding.

Furthermore, in the step (A′), the negative electrode connection member 7 is arranged so that the positional relationship becomes the same as the positional relationship illustrated in FIG. 15B with respect to the negative electrode terminal portions 12A to 12D. Subsequently, as illustrated in FIG. 16, the facing part 713D of the negative electrode connecting portion 71D and the negative electrode terminal portion 12D are brought into contact with each other, and ultrasonic welding is performed on the contact surface, thereby joining the facing part 713D and the negative electrode terminal portion 12D to each other by welding. Specifically, the anvil 92A is inserted between the negative electrode connecting portions 71C and 71D from the lateral side, and the second welding end 912 of the horn 91A is arranged above the facing part 713D of the negative electrode connecting portion 71D. Subsequently, the horn 91A is lowered to bring the leading end surface of the second welding end 912 into contact with a predetermined region RD2 of the negative electrode terminal portion 12D at a position above the facing part 713D and to sandwich the facing part 713D and the negative electrode terminal portion 12D from the top and the bottom with the horn 91A and the anvil 92A. In this state, ultrasonic waves are generated from the second welding end 912 of the horn 91A, thereby joining the facing part 713D and the negative electrode terminal portion 12D to each other by welding.

FIG. 17 is a perspective view used for illustrating the step (B′) included in the first welding step. In the step (B′), the positive electrode connecting portion 61C and the positive electrode terminal portion 11C are brought into contact with each other, and ultrasonic welding is performed on the contact surface, thereby joining the positive electrode connecting portion 61C and the positive electrode terminal portion 11C to each other by welding. Specifically, the anvil 92A is inserted between the positive electrode connecting portions 61B and 61C from the lateral side, and the second welding end 912 of the horn 91A is inserted between the positive electrode connecting portions 61C and 61D from the front. Subsequently, the horn 91A is lowered to bring the leading end surface of the second welding end 912 into contact with a predetermined region RC1 of the positive electrode connecting portion 61C and to sandwich the positive electrode connecting portion 61C and the positive electrode terminal portion 11C from the top and the bottom with the horn 91A and the anvil 92A. In this state, ultrasonic waves are generated from the second welding end 912 of the horn 91A, thereby joining the positive electrode connecting portion 61C and the positive electrode terminal portion 11C to each other by welding.

Furthermore, in the step (B′), as illustrated in FIG. 17, the negative electrode connecting portion 71C and the negative electrode terminal portion 12C are brought into contact with each other, and ultrasonic welding is performed on the contact surface, thereby joining the negative electrode connecting portion 71C and the negative electrode terminal portion 12C to each other by welding. Specifically, the anvil 92A is inserted between the negative electrode connecting portions 71B and 71C from the lateral side, and the second welding end 912 of the horn 91A is inserted between the negative electrode connecting portions 71C and 71D from the front. Subsequently, the horn 91A is lowered to bring the leading end surface of the second welding end 912 into contact with a predetermined region RC2 of the negative electrode connecting portion 71C (in FIG. 17, the predetermined region RC2 overlaps with the leading end surface (lower surface) of the second welding end 912 and thus is hidden by the second welding end 912). In addition, the negative electrode connecting portion 71C and the negative electrode terminal portion 12C are sandwiched from the top and the bottom with the horn 91A and the anvil 92A. In this state, ultrasonic waves are generated from the second welding end 912 of the horn 91A, thereby joining the negative electrode connecting portion 71C and the negative electrode terminal portion 12C to each other by welding.

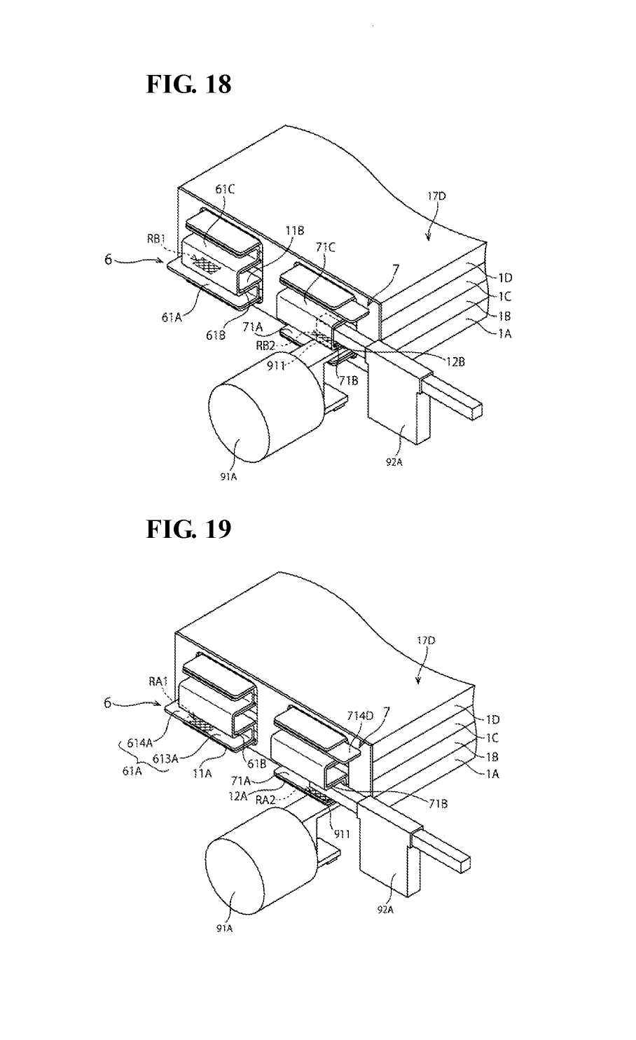

FIG. 18 is a perspective view used for illustrating the step (C′) included in the first welding step. In the step (C′), the positive electrode connecting portion 61B and the positive electrode terminal portion 11B are brought into contact with each other, and ultrasonic welding is performed on the contact surface, thereby joining the positive electrode connecting portion 61B and the positive electrode terminal portion 11B to each other by welding. Specifically, the anvil 92A is inserted between the positive electrode connecting portions 61B and 61C from the lateral side, and the first welding end 911 of the horn 91A is inserted between the positive electrode connecting portions 61A and 61B from the front. Subsequently, the horn 91A is raised to bring a leading end surface of the first welding end 911 into contact with a predetermined region RB1 of the positive electrode connecting portion 61B and to sandwich the positive electrode connecting portion 61B and the positive electrode terminal portion 11B from the top and the bottom with the horn 91A and the anvil 92A. In this state, ultrasonic waves are generated from the first welding end 911 of the horn 91A, thereby joining the positive electrode connecting portion 61B and the positive electrode terminal portion 11B to each other by welding.

Furthermore, in the step (C′), as illustrated in FIG. 18, the negative electrode connecting portion 71B and the negative electrode terminal portion 12B are brought into contact with each other, and ultrasonic welding is performed on the contact surface, thereby joining the negative electrode connecting portion 71B and the negative electrode terminal portion 12B to each other by welding. Specifically, the anvil 92A is inserted between the negative electrode connecting portions 71B and 71C from the lateral side, and the first welding end 911 of the horn 91A is inserted between the negative electrode connecting portions 71A and 71B from the front. Subsequently, the horn 91A is raised to bring the leading end surface of the first welding end 911 into contact with a predetermined region RB2 of the negative electrode connecting portion 71B and to sandwich the negative electrode connecting portion 71B and the negative electrode terminal portion 12B from the top and the bottom with the horn 91A and the anvil 92A. In this state, ultrasonic waves are generated from the first welding end 911 of the horn 91A, thereby joining the negative electrode connecting portion 71B and the negative electrode terminal portion 12B to each other by welding.

FIG. 19 is a perspective view used for illustrating the step (D′) included in the first welding step. In the step (D′), a facing part 613A of the positive electrode connecting portion 61A and the positive electrode terminal portion 11A are brought into contact with each other, and ultrasonic welding is performed on the contact surface, thereby joining the facing part 613A and the positive electrode terminal portion 11A to each other by welding. Specifically, the anvil 92A is inserted between the positive electrode connecting portions 61A and 61B from the lateral side, and the first welding end 911 of the horn 91A is arranged below the facing part 613A of the positive electrode connecting portion 61A. Subsequently, the horn 91A is raised to bring the leading end surface of the first welding end 911 into contact with a predetermined region RA1 of the positive electrode terminal portion 11A at a position below the facing part 613A and to sandwich the facing part 613A and the positive electrode terminal portion 11A from the top and the bottom with the horn 91A and the anvil 92A. In this state, ultrasonic waves are generated from the first welding end 911 of the horn 91A, thereby joining the facing part 613A and the positive electrode terminal portion 11A to each other by welding.

Furthermore, in the step (D′), as illustrated in FIG. 19, the negative electrode connecting portion 71A and the negative electrode terminal portion 12A are brought into contact with each other, and ultrasonic welding is performed on the contact surface, thereby joining the negative electrode connecting portion 71A and the negative electrode terminal portion 12A to each other by welding. Specifically, the anvil 92A is inserted between the negative electrode connecting portions 71A and 71B from the lateral side, and the first welding end 911 of the horn 91A is arranged below the negative electrode connecting portion 71A. Subsequently, the horn 91A is raised to bring the leading end surface of the first welding end 911 into contact with a predetermined region RA2 of the negative electrode terminal portion 12A at a position below the negative electrode connecting portion 71A and to sandwich the negative electrode connecting portion 71A and the negative electrode terminal portion 12A from the top and the bottom with the horn 91A and the anvil 92A. In this state, ultrasonic waves are generated from the first welding end 911 of the horn 91A, thereby joining the negative electrode connecting portion 71A and the negative electrode terminal portion 12A to each other by welding.

In the production method of the first modification, since all the electrode groups 1A to 1D are stacked in the step (A′), the work necessary in the production method of the above embodiment, that is, the work in which the electrode groups 1A to 1D are sequentially stacked in the steps (A) to (D) is unnecessary. Accordingly, it is sufficient that the work necessary in the steps (A′) to (D′) is a simple operation in which the horn 91A and the anvil 92A are moved upward or downward relative to the stacked electrode groups 1A to 1D. Consequently, according to the production method of the first modification, the production of the rectangular electricity storage device is simplified.

[3-2] Second Modification

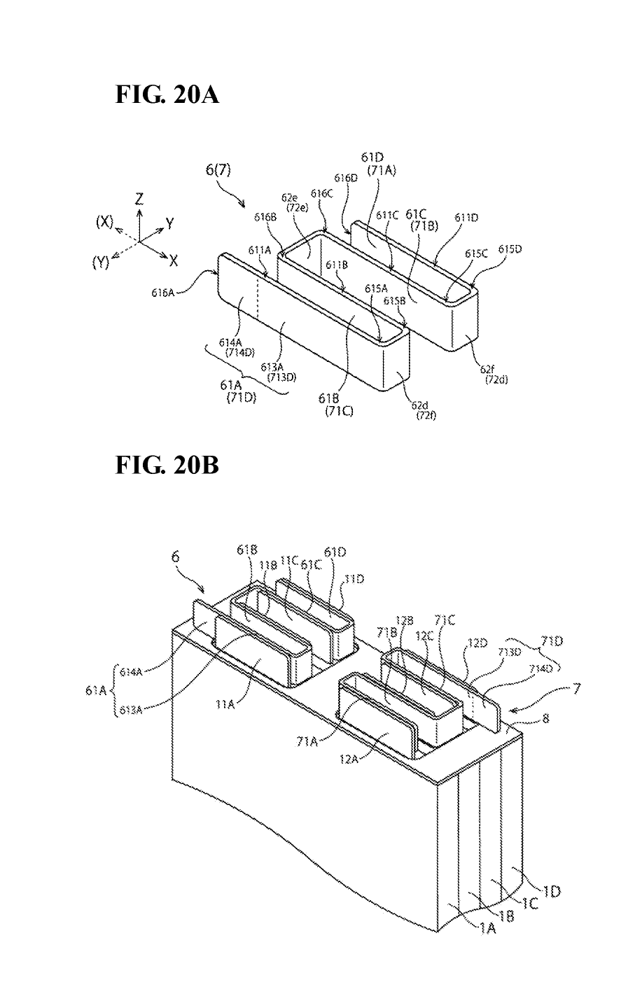

FIG. 20A is a perspective view illustrating a structure of each of a positive electrode connection member 6 and a negative electrode connection member 7 included in a rectangular electricity storage device according to a second modification. FIG. 20B is a perspective view illustrating a state in which the positive electrode connection member 6 and the negative electrode connection member 7 are connected to electrode groups 1A to 1D. The difference from the structure of the rectangular electricity storage device of the above embodiment will be mainly described in detail below.

<Positive Electrode Connection Member>

In the second modification, as illustrated in FIG. 20A, a facing part 613A of a positive electrode connecting portion 61A faces the whole of a positive electrode connecting portion 61B. Regarding a positive electrode connecting portion 61D, the whole of the positive electrode connecting portion 61D faces a positive electrode connecting portion 61C. The positive electrode connecting portions 61A to 61D respectively include first side edges 615A to 615D directed in the X-direction and second side edges 616A to 616D directed in a direction opposite to the X-direction. The first side edge 615A of the positive electrode connecting portion 61A and the first side edge 615B of the positive electrode connecting portion 61B are mechanically and electrically coupled to each other with a positive electrode coupling portion 62d therebetween. The second side edge 616B of the positive electrode connecting portion 61B and the second side edge 616C of the positive electrode connecting portion 61C are mechanically and electrically coupled to each other with a positive electrode coupling portion 62e therebetween. Furthermore, the first side edge 615C of the positive electrode connecting portion 61C and the first side edge 615D of the positive electrode connecting portions 61D are mechanically and electrically coupled to each other with a positive electrode coupling portion 62f therebetween. Accordingly, in the second modification, the whole of first edges 611A to 611D are exposed without being coupled to positive electrode coupling portions. Other structures are the same as those of the positive electrode connection member 6 illustrated in FIGS. 7A and 7B, and thus a description thereof is omitted.

As illustrated in FIG. 20B (also refer to FIG. 2), the positive electrode connection member 6 is arranged in the following positional relationship with respect to the positive electrode terminal portions 11A to 11D. Specifically, the facing part 613A of the positive electrode connecting portion 61A faces the first surface 111A of the positive electrode terminal portion 11A. The whole of the positive electrode connecting portion 61B faces the second surface 112B of the positive electrode terminal portion 11B. The whole of the positive electrode connecting portion 61C faces the first surface 111C of the positive electrode terminal portion 11C. The whole of the positive electrode connecting portion 61D faces the second surface 112D of the positive electrode terminal portion 11D. Herein, the positive electrode coupling portions 62d to 62f (refer to FIG. 20A) each have such dimensions that the positive electrode connection member 6 can be arranged with respect to the positive electrode terminal portions 11A to 11D without deforming the positive electrode terminal portions 11A to 11D or with a small amount of deformation of the positive electrode terminal portions 11A to 11D.

In this arrangement relationship, the positive electrode connection member 6 is welded to the positive electrode terminal portions 11A to 11D as follows. Specifically, the positive electrode connecting portion 61A is welded to the first surface 111A of the positive electrode terminal portion 11A in the facing part 613A thereof. The positive electrode connecting portion 61B is welded to the second surface 112B of the positive electrode terminal portion 11B. The positive electrode connecting portion 61C is welded to the first surface 111C of the positive electrode terminal portion 11C. The positive electrode connecting portion 61D is welded to the second surface 112D of the positive electrode terminal portion 11D.

Furthermore, the positive electrode connecting portion 61A is welded to the positive electrode projecting portion 43 in a non-facing part 614A thereof (refer to FIG. 3). In this manner, the positive electrode plates 14 included in each of the electrode groups 1A to 1D are electrically connected to the positive electrode external terminal 42 through the positive electrode connection member 6.

<Negative Electrode Connection Member>

In the second modification, the negative electrode connection member 7 has the same shape and the same dimensions as the positive electrode connection member 6. A negative electrode connecting portion 71A corresponds to the positive electrode connecting portion 61D, a negative electrode connecting portion 71B corresponds to the positive electrode connecting portion 61C, a negative electrode connecting portion 71C corresponds to the positive electrode connecting portion 61B, and a negative electrode connecting portion 71D corresponds to the positive electrode connecting portion 61A (refer to FIG. 20A). A negative electrode coupling portion 72d corresponds to the positive electrode coupling portion 62f. A negative electrode coupling portion 72e corresponds to the positive electrode coupling portion 62e. A negative electrode coupling portion 72f corresponds to the positive electrode coupling portion 62d. The negative electrode connection member 7 may have a shape and dimensions different from those of the positive electrode connection member 6.

As illustrated in FIG. 20B (also refer to FIG. 2), the negative electrode connection member 7 is arranged in the following positional relationship with respect to the negative electrode terminal portions 12A to 12D. Specifically, the whole of the negative electrode connecting portion 71A faces the first surface 121A of the negative electrode terminal portion 12A. The whole of the negative electrode connecting portion 71B faces the second surface 122B of the negative electrode terminal portion 12B. The whole of the negative electrode connecting portion 71C faces the first surface 121C of the negative electrode terminal portion 12C. A facing part 713D of the negative electrode connecting portion 71D faces the second surface 122D of the negative electrode terminal portion 12D. Herein, the negative electrode coupling portions 72d to 72f (FIG. 20A) each have such dimensions that the negative electrode connection member 7 can be arranged with respect to the negative electrode terminal portions 12A to 12D without deforming the negative electrode terminal portions 12A to 12D or with a small amount of deformation of the negative electrode terminal portions 12A to 12D.

In this arrangement relationship, the negative electrode connection member 7 is welded to the negative electrode terminal portions 12A to 12D as follows. Specifically, the negative electrode connecting portion 71A is welded to the first surface 121A of the negative electrode terminal portion 12A. The negative electrode connecting portion 71B is welded to the second surface 122B of the negative electrode terminal portion 12B. The negative electrode connecting portion 71C is welded to the first surface 121C of the negative electrode terminal portion 12C. The negative electrode connecting portion 71D is welded to the second surface 122D of the negative electrode terminal portion 12D in the facing part 713D thereof

Furthermore, the negative electrode connecting portion 71D is welded to the negative electrode projecting portion 53 in a non-facing part 714D thereof (refer to FIG. 4). In this manner, the negative electrode plates 15 included in each of the electrode groups 1A to 1D are electrically connected to the negative electrode external terminal 52 through the negative electrode connection member 7.

According to the rectangular electricity storage device of the second modification, as in the rectangular electricity storage device of the embodiment described above, even before the electrode groups 1A to 1D are housed in the outer package can 2, the positive electrode projecting portion 43 and the negative electrode projecting portion 53 that are fixed to the cover plate 3 can be welded to the positive electrode connection member 6 and the negative electrode connection member 7, respectively, without causing misalignment of the electrode groups 1A to 1D. Accordingly, the rectangular electricity storage device of the second modification does not require the space for housing lead plates that are folded, the space being necessary for the existing rectangular electricity storage device (refer to FIG. 25). Therefore, the ratio of the total volume of the electrode groups 1A to 1D to the volume of the rectangular electricity storage device increases, resulting in an improvement in the volume energy density.

Furthermore, according to the rectangular electricity storage device of the second modification, the thickness of each of the positive electrode connection member 6 and the negative electrode connection member 7 can be increased as in the rectangular electricity storage device of the embodiment described above. Accordingly, the electrical resistance of the positive electrode connection member 6 is low, and an energy loss between the positive electrode external terminal 42 and the electrode groups 1A to 1D is decreased. Similarly, the electrical resistance of the negative electrode connection member 7 is low, and an energy loss between the negative electrode external terminal 52 and the electrode groups 1A to 1D is decreased.

<Method for Producing Rectangular Electricity Storage Device>

In a method for producing the rectangular electricity storage device of the second modification, a preparation step, a first welding step, a second welding step, and a sealing step are sequentially performed. In the first welding step, steps (A′) to (D′) are sequentially performed. Since the preparation step, the second welding step, and the sealing step are the same as those in the above embodiment, a description thereof is omitted. The first welding step will now be described with reference to the drawings.

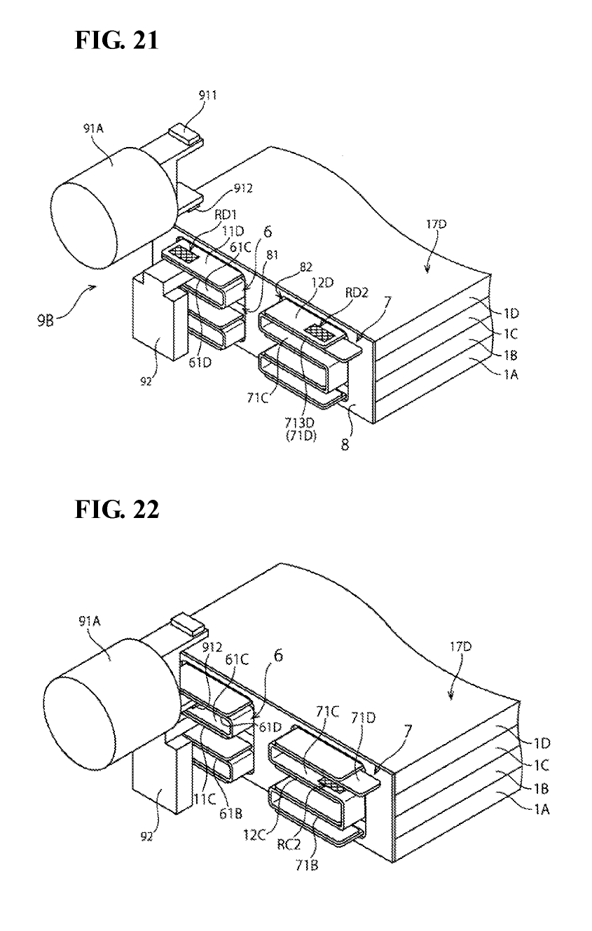

FIG. 21 is a perspective view used for illustrating the step (A′) included in the first welding step. As illustrated in FIG. 21, in the step (A′), first, electrode groups 1A to 1D are stacked so that all positive electrode terminal portions 11A to 11D and negative electrode terminal portions 12A to 12D provided on the electrode groups 1A to 1D are oriented in the same direction. At this time, the electrode groups 1A to 1D are stacked so that the positive electrode terminal portions 11A to 11D face each other and the negative electrode terminal portions 12A to 12D face each other. The electrode groups 1A to 1D are arranged so that the positive electrode terminal portions 11A to 11D and the negative electrode terminal portions 12A to 12D are oriented in the horizontal direction, and a first surface 17D (surface oriented in the Y-direction in the assembled state of the rectangular electricity storage device (refer to FIG. 2)) of the electrode group 1D is oriented upward. Furthermore, an electric insulation sheet 8 is arranged in a state in which the positive electrode terminal portions 11A to 11D and the negative electrode terminal portions 12A to 12D are respectively passed through windows 81 and 82 formed in the electric insulation sheet 8.

Next, the positive electrode connection member 6 is arranged so that the positional relationship becomes the same as the positional relationship illustrated in FIG. 20B with respect to the positive electrode terminal portions 11A to 11D. Subsequently, as illustrated in FIG. 21, the positive electrode connecting portion 61D and the positive electrode terminal portion 11D are brought into contact with each other, and ultrasonic welding is performed on the contact surface, thereby joining the positive electrode connecting portion 61D and the positive electrode terminal portion 11D to each other by welding. For the ultrasonic welding, an ultrasonic welder 9B including the horn 91A used in the first modification and the anvil 92 used in the embodiment is used. Specifically, the anvil 92 is inserted between the positive electrode connecting portions 61C and 61D from the front, and the second welding end 912 of the horn 91A is arranged above the positive electrode connecting portion 61D. Subsequently, the horn 91A is lowered to bring the leading end surface of the second welding end 912 into contact with a predetermined region RD1 of the positive electrode terminal portion 11D at a position above the positive electrode connecting portion 61D and to sandwich the positive electrode connecting portion 61D and the positive electrode terminal portion 11D from the top and the bottom with the horn 91A and the anvil 92. In this state, ultrasonic waves are generated from the second welding end 912 of the horn 91A, thereby joining the positive electrode connecting portion 61D and the positive electrode terminal portion 11D to each other by welding.

Furthermore, in the step (A′), the negative electrode connection member 7 is arranged so that the positional relationship becomes the same as the positional relationship illustrated in FIG. 20B with respect to the negative electrode terminal portions 12A to 12D. Subsequently, the facing part 713D of the negative electrode connecting portion 71D and the negative electrode terminal portion 12D are brought into contact with each other, and ultrasonic welding is performed on the contact surface, thereby joining the facing part 713D and the negative electrode terminal portion 12D to each other by welding. Specifically, the anvil 92 is inserted between the negative electrode connecting portions 71C and 71D from the front, and the second welding end 912 of the horn 91A is arranged above the facing part 713D of the negative electrode connecting portion 71D. Subsequently, the horn 91A is lowered to bring the leading end surface of the second welding end 912 into contact with a predetermined region RD2 of the negative electrode terminal portion 12D at a position above the facing part 713D and to sandwich the facing part 713D and the negative electrode terminal portion 12D from the top and the bottom with the horn 91A and the anvil 92. In this state, ultrasonic waves are generated from the second welding end 912 of the horn 91A, thereby joining the facing part 713D and the negative electrode terminal portion 12D to each other by welding.

FIG. 22 is a perspective view used for illustrating the step (B′) included in the first welding step. As illustrated in FIG. 22, in the step (B′), the positive electrode connecting portion 61C and the positive electrode terminal portion 11C are brought into contact with each other, and ultrasonic welding is performed on the contact surface, thereby joining the positive electrode connecting portion 61C and the positive electrode terminal portion 11C to each other by welding. Specifically, the anvil 92 is inserted between the positive electrode connecting portions 61B and 61C from the front, and the second welding end 912 of the horn 91A is inserted between the positive electrode connecting portions 61C and 61D from the front. Subsequently, the horn 91A is lowered to bring the leading end surface of the second welding end 912 into contact with a predetermined region RC1 of the positive electrode connecting portion 61C (in FIG. 22, the predetermined region RC1 overlaps with the leading end surface (lower surface) of the second welding end 912 and thus is hidden by the second welding end 912). In addition, the positive electrode connecting portion 61C and the positive electrode terminal portion 11C are sandwiched from the top and the bottom with the horn 91A and the anvil 92. In this state, ultrasonic waves are generated from the second welding end 912 of the horn 91A, thereby joining the positive electrode connecting portion 61C and the positive electrode terminal portion 11C to each other by welding.

Furthermore, in the step (B′), the negative electrode connecting portion 71C and the negative electrode terminal portion 12C are brought into contact with each other, and ultrasonic welding is performed on the contact surface, thereby joining the negative electrode connecting portion 71C and the negative electrode terminal portion 12C to each other by welding. Specifically, the anvil 92 is inserted between the negative electrode connecting portions 71B and 71C from the front, and the second welding end 912 of the horn 91A is inserted between the negative electrode connecting portions 71C and 71D from the front. Subsequently, the horn 91A is lowered to bring the leading end surface of the second welding end 912 into contact with a predetermined region RC2 of the negative electrode connecting portion 71C and to sandwich the negative electrode connecting portion 71C and the negative electrode terminal portion 12C from the top and the bottom with the horn 91A and the anvil 92. In this state, ultrasonic waves are generated from the second welding end 912 of the horn 91A, thereby joining the negative electrode connecting portion 71C and the negative electrode terminal portion 12C to each other by welding.

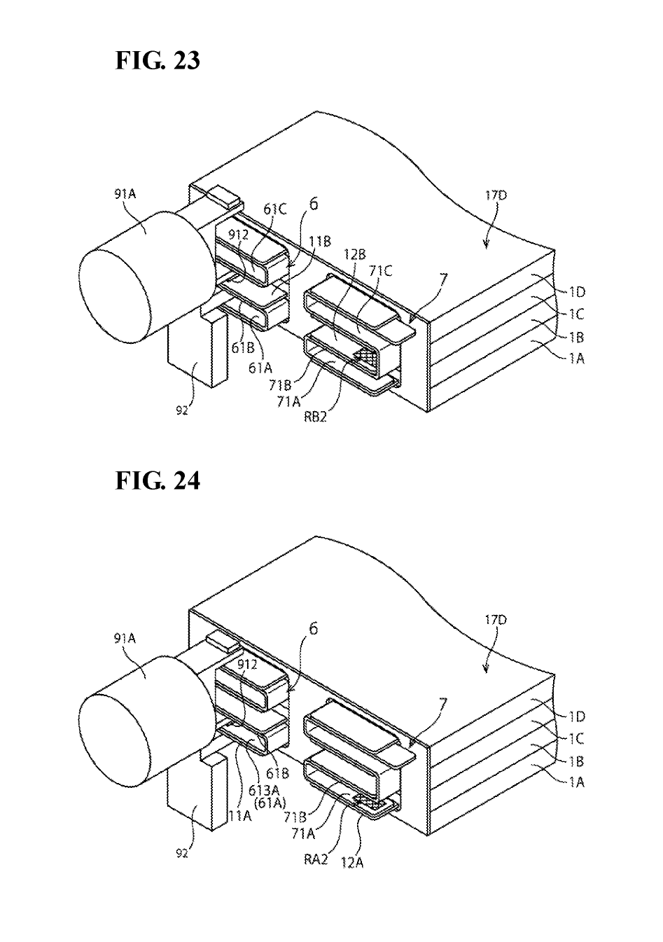

FIG. 23 is a perspective view used for illustrating the step (C′) included in the first welding step. As illustrated in FIG. 23, in the step (C′), the positive electrode connecting portion 61B and the positive electrode terminal portion 11B are brought into contact with each other, and ultrasonic welding is performed on the contact surface, thereby joining the positive electrode connecting portion 61B and the positive electrode terminal portion 11B to each other by welding. Specifically, the anvil 92 is inserted between the positive electrode connecting portions 61A and 61B from the front, and the second welding end 912 of the horn 91A is inserted between the positive electrode connecting portions 61B and 61C from the front. Subsequently, the horn 91A is lowered to bring the leading end surface of the second welding end 912 into contact with a predetermined region RB1 of the positive electrode terminal portion 11B (in FIG. 23, the predetermined region RB1 overlaps with the leading end surface (lower surface) of the second welding end 912 and thus is hidden by the second welding end 912) at a position above the positive electrode connecting portion 61B. In addition, the positive electrode connecting portion 61B and the positive electrode terminal portion 11B are sandwiched from the top and the bottom with the horn 91A and the anvil 92. In this state, ultrasonic waves are generated from the second welding end 912 of the horn 91A, thereby joining the positive electrode connecting portion 61B and the positive electrode terminal portion 11B to each other by welding.

Furthermore, in the step (C′), the negative electrode connecting portion 71B and the negative electrode terminal portion 12B are brought into contact with each other, and ultrasonic welding is performed on the contact surface, thereby joining the negative electrode connecting portion 71B and the negative electrode terminal portion 12B to each other by welding. Specifically, the anvil 92 is inserted between the negative electrode connecting portions 71A and 71B from the front, and the second welding end 912 of the horn 91A is inserted between the negative electrode connecting portions 71B and 71C from the front. Subsequently, the horn 91A is lowered to bring the leading end surface of the second welding end 912 into contact with a predetermined region RB2 of the negative electrode terminal portion 12B at a position above the negative electrode connecting portion 71B and to sandwich the negative electrode connecting portion 71B and the negative electrode terminal portion 12B from the top and the bottom with the horn 91A and the anvil 92. In this state, ultrasonic waves are generated from the second welding end 912 of the horn 91A, thereby joining the negative electrode connecting portion 71B and the negative electrode terminal portion 12B to each other by welding.

FIG. 24 is a perspective view used for illustrating the step (D′) included in the first welding step. As illustrated in FIG. 24, in the step (D′), a facing part 613A of the positive electrode connecting portion 61A and the positive electrode terminal portion 11A are brought into contact with each other, and ultrasonic welding is performed on the contact surface, thereby joining the facing part 613A and the positive electrode terminal portion 11A to each other by welding. Specifically, the anvil 92 is arranged at a position below the facing part 613A of the positive electrode connecting portion 61A. At this time, the anvil 92 is brought into contact with the lower surface (the second surface 112A illustrated in FIG. 2) of the positive electrode terminal portion 11A. The second welding end 912 of the horn 91A is inserted between the positive electrode connecting portions 61A and 61B from the front. Subsequently, the horn 91A is lowered to bring the leading end surface of the second welding end 912 into contact with a predetermined region RA1 of the facing part 613A (in FIG. 24, the predetermined region RA1 overlaps with the leading end surface (lower surface) of the second welding end 912 and thus is hidden by the second welding end 912). In addition, the facing part 613A and the positive electrode terminal portion 11A are sandwiched from the top and the bottom with the horn 91A and the anvil 92. In this state, ultrasonic waves are generated from the second welding end 912 of the horn 91A, thereby joining the facing part 613A and the positive electrode terminal portion 11A to each other by welding.

Furthermore, in the step (D′), the negative electrode connecting portion 71A and the negative electrode terminal portion 12A are brought into contact with each other, and ultrasonic welding is performed on the contact surface, thereby joining the negative electrode connecting portion 71A and the negative electrode terminal portion 12A to each other by welding. Specifically, the anvil 92 is arranged at a position below the negative electrode connecting portion 71A. At this time, the anvil 92 is brought into contact with the lower surface (the second surface 122A illustrated in FIG. 2) of the negative electrode terminal portion 12A. The second welding end 912 of the horn 91A is inserted between the negative electrode connecting portions 71A and 71B from the front. Subsequently, the horn 91A is lowered to bring the leading end surface of the second welding end 912 into contact with a predetermined region RA2 of the negative electrode connecting portion 71A and to sandwich the negative electrode connecting portion 71A and the negative electrode terminal portion 12A from the top and the bottom with the horn 91A and the anvil 92. In this state, ultrasonic waves are generated from the second welding end 912 of the horn 91A, thereby joining the negative electrode connecting portion 71A and the negative electrode terminal portion 12A to each other by welding.

In the production method of the second modification, since all the electrode groups 1A to 1D are stacked in the step (A′), the work necessary in the production method of the above embodiment, that is, the work in which the electrode groups 1A to 1D are sequentially stacked in the steps (A) to (D) is unnecessary. Accordingly, it is sufficient that the work necessary in the steps (A′) to (D′) is a simple operation in which the horn 91A and the anvil 92 are moved upward or downward relative to the stacked electrode groups 1A to 1D. Consequently, according to the production method of the second modification, the production of the rectangular electricity storage device is simplified.

The structures of respective portions of the present invention are not limited to the embodiments described above, and various modifications can be made within the technical scope described in claims. For example, in the rectangular electricity storage device, instead of the welding to the positive electrode connection member 6 or in addition to the welding, the positive electrode projecting portion 43 may be welded to at least any one of the positive electrode terminal portions 11A to 11D. Instead of the welding to the negative electrode connection member 7 or in addition to the welding, the negative electrode projecting portion 53 may be welded to at least any one of the negative electrode terminal portions 12A to 12D.

In the rectangular electricity storage device, the positive electrode terminal member 4 and the positive electrode connection member 6 may not be provided, and the positive electrode plates 14 included in each of the electrode groups 1A to 1D may be electrically connected to the inner surface of the outer package can 2 having electrical conductivity. In this case, at least a part of the outer peripheral surface of the outer package can 2 is used as a positive electrode external terminal. In the rectangular electricity storage device, the negative electrode terminal member 5 and the negative electrode connection member 7 may not be provided, and the negative electrode plates 15 included in each of the electrode groups 1A to 1D may be electrically connected to the inner surface of the outer package can 2 having electrical conductivity. In this case, at least a part of the outer peripheral surface of the outer package can 2 is used as a negative electrode external terminal.

Furthermore, the structures of respective portions of the rectangular electricity storage device can be applied to various secondary batteries and capacitors, such as a lead storage battery, a lithium-ion battery, a sodium-ion battery, a molten-salt battery, a lithium-ion capacitor, and an electric double-layer capacitor as long as they are rectangular electricity storage devices in which a plurality of electrode groups are housed in the outer package can 2 in a state where the electrode groups are stacked. The structures of respective portions of the rectangular electricity storage device may be applied to primary batteries.

The rectangular electricity storage device and the method for producing the rectangular electricity storage device according to the present invention are useful as, for example, large-scale power storage devices for household or industrial use and power supplies installed in an electric vehicle or a hybrid vehicle.

1. A rectangular electricity storage device comprising:
a first electrode group and a second electrode group each of which includes a plurality of first electrode plates and a plurality of second electrode plates having a polarity opposite to the first electrode plates, the first electrode plates and the second electrode plates being stacked;
a bottom-closed cylindrical outer package can in which the first electrode group and the second electrode group are housed in a stacked state;
a cover plate that seals an opening of the outer package can;
an external terminal disposed on the cover plate; and
a connection member that mechanically and electrically couples the first electrode group and the second electrode group to each other,
wherein the first electrode plates are each provided with an electrode tab that protrudes from an edge toward the opening, the edge facing the opening,
the first electrode group is provided with a first terminal portion that extends from an end surface toward the opening, the end surface facing the opening, the electrode tabs provided on the first electrode plates belonging to the first electrode group overlap and form a bundle, and the bundle constitutes the first terminal portion,
the second electrode group is provided with a second terminal portion that extends from an end surface toward the opening, the end surface facing the opening, the electrode tabs provided on the first electrode plates belonging to the second electrode group overlap and form a bundle, and the bundle constitutes the second terminal portion,
the connection member includes
a first connecting portion welded to the first terminal portion,
a second connecting portion welded to the second terminal portion, and
a coupling portion that mechanically and electrically couples the first connecting portion and the second connecting portion to each other, and
an inner surface of the cover plate is provided with a projecting portion that extends from the inner surface toward a bottom surface of the outer package can, and the projecting portion is electrically connected to the external terminal and is welded to at least any one of the first terminal portion, the second terminal portion, and the connection member.

2. The rectangular electricity storage device according to claim 1, wherein the first terminal portion and the second terminal portion each have a first surface oriented in a first direction that is the same as a direction in which the first electrode group and the second electrode group are stacked and a second surface oriented in a direction opposite to the first direction, the first connecting portion and the second connecting portion are welded to the first surface of the first terminal portion and the second surface of the second terminal portion, respectively,
the first connecting portion and the second connecting portion each have a first edge facing the opening and a second edge on the side opposite to the opening, and the first edges or the second edges are mechanically and electrically coupled to each other by the coupling portion.

3. The rectangular electricity storage device according to claim 2, wherein the first surface of the first terminal portion and the second surface of the second terminal portion are surfaces that face each other, and the second edges are mechanically and electrically coupled to each other by the coupling portion.

4. The rectangular electricity storage device according to claim 2, wherein the first surface of the first terminal portion and the second surface of the second terminal portion are respectively a back surface of the second surface of the first terminal portion and a back surface of the first surface of the second terminal portion, the second surface of the first terminal portion and the first surface of the second terminal portion facing each other, and the first edges are mechanically and electrically coupled to each other by the coupling portion.

5. The rectangular electricity storage device according to claim 4, wherein the first edge of the first connecting portion and the first edge of the second connecting portion each have a coupled region to which the coupling portion is coupled and an exposed region to which the coupling portion is not coupled, and
the first connecting portion and the second connecting portion are respectively welded to the first terminal portion and the second terminal portion in a part close to the exposed region.

6. The rectangular electricity storage device according to claim 1, wherein the first connecting portion includes a facing part that faces the second connecting portion, and a non-facing part that does not face the second connecting portion, and
the first connecting portion is welded to the first terminal portion or the projecting portion in the non-facing part.

7. The rectangular electricity storage device according to claim 1, wherein the first connecting portion and the second connecting portion each have a side edge, and the side edges are mechanically and electrically connected to each other by the coupling portion.

8. The rectangular electricity storage device according to claim 1, wherein, in a direction from the bottom surface to the opening of the outer package can, a ratio of a height of the first terminal portion from the end surface, the first terminal portion being provided on the first electrode group, to a distance from the end surface of the first electrode group to the inner surface of the cover plate, the end surface facing the opening, is 0.9 or less.

9. The rectangular electricity storage device according to claim 1, wherein the connection member is formed of at least one metal selected from the group consisting of aluminum, copper, and nickel.

10. A method for producing a rectangular electricity storage device, the device being the rectangular electricity storage device according to claim 1, the method comprising:
(i) a step of preparing the connection member;
(ii) a step of welding the first terminal portion provided on the first electrode group to the first connecting portion of the connection member;
(iii) a step of stacking the second electrode group on the first electrode group, and welding the second terminal portion provided on the second electrode group to the second connecting portion of the connection member;
(iv) a step of welding, after the steps (i) to (iii), the projecting portion provided on the inner surface of the cover plate to at least any one of the first terminal portion, the second terminal portion, and the connection member; and
(v) a step of housing, after the step (iv), the first electrode group and the second electrode group in the outer package can, and sealing the opening of the outer package can with the cover plate.

11. The method for producing the rectangular electricity storage device according to claim 10, wherein, in the step (i), the first connecting portion, the second connecting portion, and the coupling portion of the connection member are formed by bending a single metal flat plate.

12. The method for producing the rectangular electricity storage device according to claim 11, wherein the metal flat plate has a thickness of 0.5 mm or more and 1.5 mm or less.
